(19) United States
(12) Patent Application Publication
(10) Pub. No.: US 2026/0329852 A1
(43) Pub. Date: Oct. 22, 2026

(54) METHOD AND SYSTEM FOR ENABLING AN LLM TO REASON WITH STRUCTURED DATA

(71) Applicant: MAXA AI INC., Montreal (CA)

(72) Inventors: Raphael Steinman, Montreal (CA); Sebastien Coutu, Montreal (CA)

(21) Appl. No.: 19/648,218

(22) Filed: Apr. 15, 2026

Related U.S. Application Data
(60) Provisional application No. 63/789,731, filed on Apr. 16, 2025.

(51) Int. Cl. G06F 16/242; G06F 16/248; G06F 16/28; G06N 5/04

(52) U.S. Cl. CPC G06F 16/243; G06F 16/248; G06F 16/285; G06N 5/04

(57) ABSTRACT

There is provided a method for receiving a question; generating an initial query based on the question and sending the initial query to the LLM; receiving a data request from the LLM in response to the query; processing the data request to construct at least one model-specific query; executing the at least one model-specific query against one or more authoritative sources of structured data, thereby obtaining a structured data result; generating a contextual narrative based on the structured data result and sending the contextual narrative to the LLM; receiving a complete response to the initial query from the LLM; and outputting the complete response.

### CROSS-REFERENCE TO RELATED APPLICATIONS

The present application claims priority on U.S. Provisional Application No. 63/789,731 filed on Apr. 16, 2025, the content of which is incorporated herein by reference.

### FIELD

The present technology relates to LLM interactions and more specifically to methods, systems, and non-transitory storage mediums for enabling an LLM to reason with structured enterprise data.

### BACKGROUND

Conventional large language models (LLMs) suffer from “hallucinations”, i.e., when a model generates a response that is incorrect or fabricated. LLMs excel at textual reasoning but struggle to accurately interpret and utilize structured data such as data stored in the form of rows and columns. This disconnect amplifies occurrences of hallucinations with structured data. For example, enterprises seeking to leverage the powerful linguistic capabilities of LLMs thus face significant challenges in maintaining data fidelity and consistency.

When using LLMs, there is often a mismatch between textual reasoning and structured data. LLMs are not inherently designed to parse and process columns, rows, and relational schemas.

LLMs may provide only an incomplete understanding and may hallucinate. Due to limited structured-data context, LLMs frequently produce erroneous or unverified results, undermining confidence in automated output.

LLMs may exhibit a loss of accuracy in enterprise data access. Conventional methods for attempting to bridge LLMs and structured data often sacrifice precision to achieve natural language compatibility.

There exists a need for an improved method and/or system that overcomes at least some of the deficiencies described above.

### SUMMARY

It is an object of the present technology to ameliorate at least some of the inconveniences present in the prior art. One or more implementations of the present technology may provide and/or broaden the scope of approaches to and/or methods of achieving the aims and objects of the present technology.

Developers of the present technology have appreciated that there is a need for a system that enables an LLM to reason with structured data, such as structured enterprise data, to provide reliable results.

One of the objectives of the embodiments of the present technology is to bridge text-based LLM Reasoning with structured data. This includes providing a framework that preserves the fidelity of tabular and event-based information while integrating seamlessly with LLM reasoning processes.

In one or more implementations, another objective is to detect and eliminate/reduce hallucinations. This includes implementing deterministic checks that systematically compare generated outputs against authoritative data stores, reducing inaccuracies.

In one or more implementations, another objective is to establish a unified representation. This includes facilitating a single, cohesive model that treats structured data in a manner compatible with natural language reasoning, thereby supporting both precise queries and intuitive understanding.

In one or more implementations, another objective is to ensure accessible yet accurate enterprise data. This includes delivering a solution that maintains high reliability when transforming structured records into a text-based format interpretable by LLMs, without compromising on data integrity.

Thus, one or more implementations of the present technology are directed to a method of and a system for enabling an LLM to reason with structured data such as structured enterprise data.

According to a first broad aspect, there is provided a system for enabling a large language model (LLM) to reason with structured data, the system comprising: a processor; and a non-transitory storage medium operatively connected to the processor, the non-transitory storage medium comprising computer-readable instructions; the processor, upon executing the instructions, being configured for: receiving a question; generating an initial query based on the question and sending the initial query to the LLM; receiving a data request from the LLM in response to the query; processing the data request to construct at least one model-specific query; executing the at least one model-specific query against one or more authoritative sources of structured data, thereby obtaining a structured data result; generating a contextual narrative based on the structured data result and sending the contextual narrative to the LLM; receiving a complete response to the initial query from the LLM; and outputting the complete response.

In one or more implementations, the processor is further configured for: verifying claims made in the complete response against the one or more authoritative sources, thereby generating categorizations of each of the claims that were verified; and generating a final response based on the complete response and the categorizations, wherein said outputting the complete response comprises outputting the final response.

In one or more implementations, the question is a business question and the processor is further configured for applying at least one of a business context and instructions to the business question to prepare the initial query.

In one or more implementations, wherein the sending the initial query to the LLM causes the LLM to carry out an initial reasoning process on the query.

In one or more implementations, the data request is protocol-conformant and follows a standardized protocol specification.

In one or more implementations, said processing the data request comprises inputting the data request through a universal data modeling interface with appropriate data model adapters.

In one or more implementations, the processor is further configured for constructing the at least one model-specific query from the data request using the data model adapters.

In one or more implementations, said executing the at least one model-specific query against the one or more authoritative sources of structured data is carried out using the data model adapters.

In one or more implementations, said generating the contextual narrative is performed using a narrative transformation engine that maintains bidirectional mappings.

In one or more implementations, said sending the contextual narrative to the LLM causes the LLM to incorporate the contextual narrative into a subsequent reasoning process to generate the complete response to the initial query.

In one or more implementations, the processor is further configured for extracting the claims from the complete response for verification.

In one or more implementations, said verifying the claims made in the complete response is further based on fact verification embeddings inserted into the contextual narrative and the complete response.

In one or more implementations, said verifying the claims made in the complete response generates an audit trail.

In one or more implementations, said generating the final response is further performed based on the audit trail.

In one or more implementations, said verifying the claims made in the complete response comprises using model-appropriate verification methods applied to the claims as related to the model-specific queries.

In one or more implementations, the processor is further configured for classifying each of the claims that were verified according to a verification framework that categorizes content within the claims that were verified into specific verification tiers.

In one or more implementations, a first tier claim comprises statements with direct traceability to specific source records, a second tier claim comprises statements derived through deterministic operations on first-tier elements, and a third tier claim comprises statements incorporating elements not directly traceable.

In one or more implementations, the processor is further configured for attaching the fact verification embeddings to corresponding content elements for each of the claims that were verified.

In one or more implementations, said outputting the final response comprises at least one of displaying the final response on the user interface, displaying the final response on the user device, sending the final response to the server to cause the final response to be output to a computing device connected to the server, and displaying the final response on the remote device.

According to another broad aspect, there is provided a method for enabling a large language model (LLM) to reason with structured data, the method being executed by a processor, the method comprising: receiving a question; generating an initial query based on the question and sending the initial query to the LLM; receiving a data request from the LLM in response to the query; processing the data request to construct at least one model-specific query; executing the at least one model-specific query against one or more authoritative sources of structured data, thereby obtaining a structured data result; generating a contextual narrative based on the structured data result and sending the contextual narrative to the LLM; receiving a complete response to the initial query from the LLM; and outputting the complete response.

In one or more implementations, the method further comprises: verifying claims made in the complete response against the one or more authoritative sources, thereby generating categorizations of each of the claims that were verified; and generating a final response based on the complete response and the categorizations, wherein said outputting the complete response comprises outputting the final response.

In one or more implementations, the question is a business question and the method further comprises applying at least one of a business context and instructions to the business question to prepare the initial query.

In one or more implementations, said sending the initial query to the LLM causes the LLM to carry out an initial reasoning process on the query.

In one or more implementations, the data request is protocol-conformant and follows a standardized protocol specification.

In one or more implementations, said processing the data request comprises inputting the data request through a universal data modeling interface with appropriate data model adapters.

In one or more implementations, the method further comprises constructing the at least one model-specific query from the data request using the data model adapters.

In one or more implementations, said executing the at least one model-specific query against the one or more authoritative sources of structured data is carried out using the data model adapters.

In one or more implementations, said generating the contextual narrative is performed using a narrative transformation engine that maintains bidirectional mappings.

In one or more implementations, said sending the contextual narrative to the LLM causes the LLM to incorporate the contextual narrative into a subsequent reasoning process to generate the complete response to the initial query.

In one or more implementations, the method further comprises extracting the claims from the complete response for verification.

In one or more implementations, said verifying the claims made in the complete response is further based on fact verification embeddings inserted into the contextual narrative and the complete response.

In one or more implementations, said verifying the claims made in the complete response generates an audit trail.

In one or more implementations, said generating the final response is further performed based on the audit trail.

In one or more implementations, said verifying the claims made in the complete response comprises using model-appropriate verification methods applied to the claims as related to the model-specific queries.

In one or more implementations, the method further comprises classifying each of the claims that were verified according to a verification framework that categorizes content within the claims that were verified into specific verification tiers.

In one or more implementations, the method further comprises attaching the fact verification embeddings to corresponding content elements for each of the claims that were verified.

In one or more implementations, said outputting the final response comprises at least one of displaying the final response on the user interface, displaying the final response on the user device, sending the final response to the server to cause the final response to be output to a computing device connected to the server, and displaying the final response on the remote device.

According to a further broad aspect, there is provided a non-transitory computer-readable medium having stored thereon computer-executable instructions that when executed by at least one processor cause the at least one processor to perform the method steps of any one of claims 19 to 36.

### Terms and Definitions

In the context of the present specification, a “server” is a computer program that is running on appropriate hardware and is capable of receiving requests (e.g., from computing devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “computing device” is any computing apparatus or computer hardware that is capable of running software appropriate to the relevant task at hand. Thus, some (non-limiting) examples of computing devices include general purpose personal computers (desktops, laptops, netbooks, etc.), mobile computing devices, smartphones, and tablets, and network equipment such as routers, switches, and gateways. It should be noted that a computing device in the present context is not precluded from acting as a server to other computing devices. The use of the expression “a computing device” does not preclude multiple computing devices being used in receiving/sending, carrying out or causing to be carried out any task or request, or the consequences of any task or request, or steps of any method described herein. In the context of the present specification, a “client device” refers to any of a range of end-user client computing devices, associated with a user, such as personal computers, tablets, smartphones, and the like.

In the context of the present specification, the expression “computer-readable storage medium” (also referred to as “storage medium” and “storage”) is intended to include non-transitory media of any nature and kind whatsoever, including without limitation RAM, ROM, disks (CD-ROMs, DVDs, floppy disks, hard drives, etc.), USB keys, solid state drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to, audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e., its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct wired connection, and wireless media such as acoustic, radio frequency (RF), infrared, and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy, or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware; in other cases, they may be different software and/or hardware.

In the context of the present specification, structured data refers to data that is organized according to a predefined data model or schema that defines how individual data elements are stored, related, and accessed. Structured data may be organized in various formats and paradigms including, but not limited to, tabular formats such as rows and columns, relational schemas, dimensional models, data vault architectures, hierarchical structures, graph-based structures, object-oriented models, document-oriented database collections with defined fields, columnar storage formats, and semantic data layers. Structured data is characterized by its conformance to a formal structure that enables programmatic querying, machine processing, and systematic analysis.

In the context of the present specification, enterprise data refers to the aggregate digital information generated, collected, stored, and processed within an organization, encompassing both structured data (as defined herein) and unstructured content (such as text documents, images, audio, and video). Enterprise data may be subject to data governance, management, and compliance requirements, and may support data-driven decision-making and operational efficiency. In the context of the present specification, structured enterprise data refers to the subset of enterprise data that constitutes structured data as defined herein.

In the context of the present specification, a Unified Data Model (UDM) refers to a standardized data representation framework that integrates structured data from disparate sources into a cohesive and consistent model. A UDM applied specifically to business data may be referred to as a Unified Business Data Model (UBDM).

In the context of the present specification, a claim refers to a statement, assertion, or conclusion present in a response generated by an LLM.

In the context of the present specification, a business question refers to a question pertaining to one or more aspects of an organization, such as its data, operations, performance, or strategic objectives.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a computing device in accordance with one or more non-limiting implementations of the present technology.

FIG. 2 depicts a schematic diagram of a communication system in accordance with one or more non-limiting implementations of the present technology.

FIG. 3 depicts a flowchart of a method for enabling a large language model (LLM) to reason with structured data in accordance with one or more non-limiting implementations of the present technology.

FIG. 4 depicts a flowchart of a technical workflow for enabling an LLM to reason with structured data in accordance with one or more non-limiting implementations of the present technology.

FIG. 5 depicts a schematic diagram of software modules for a system for enabling an LLM to reason with structured data in accordance with one or more non-limiting implementations of the present technology.

FIG. 6 depicts a schematic diagram of a software architecture for a system for enabling an LLM to reason with structured data in accordance with one or more non-limiting implementations of the present technology.

FIG. 7 depicts a flowchart of a method for implementing a protocol-based data transformation system for an LLM in accordance with one or more non-limiting implementations of the present technology.

FIG. 8 depicts a flowchart of a method for enabling bidirectional communication between an LLM and one or more structured data sources in accordance with one or more non-limiting implementations of the present technology.

FIG. 9 depicts a schematic diagram of software components for a system for preserving business context in data transformations for LLM reasoning in accordance with one or more non-limiting implementations of the present technology.

FIG. 10 depicts a flowchart of a method for maintaining context integrity in bidirectional data transformations in accordance with one or more non-limiting implementations of the present technology.

FIG. 11 depicts a flowchart of a data flow for LLM reasoning with structured enterprise data in accordance with one or more non-limiting implementations of the present technology.

FIG. 12 depicts a flowchart of a data flow in a semantic model for using an LLM to reason with structured data.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting implementations of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

### Overview of Example Technical Solution

An example technical solution is a system that integrates structured enterprise data—such as data organized in star schemas and other modeling frameworks—with the text-based reasoning capabilities of large language models (LLMs). First, the system converts structured data sources into an event-sourcing based unified data model (UDM), wherein each element such as each business process, user journey, or workflow is represented as a chronological series of activities or events, including triggers, conditions, outcomes, and metadata information (e.g., timestamps, lineage, governance tags).

By situating itself atop the LLM's input and output context windows and employing an adequate protocol framework such Anthropics' Model Context Protocol (MCP) framework, the system provides data-query-to-narrative translation tools. These tools are invoked through specially tagged outputs from the LLM, prompting automatic queries against the UDM. The returned data is then transformed into textual narratives, optionally augmented with fact-verification embeddings, which the LLM can parse and integrate into its reasoning. This approach allows the system to naturally reason and blend enterprise data as if it was text with the LLM's language-based inference.

In one or more implementations, to ensure factual consistency—an issue frequently encountered in conventional systems—a dedicated verification layer evaluates the LLM's intermediate or final outputs against the authoritative UDM records. Upon detecting discrepancies, the system either re-initiates the reasoning process or directly corrects the LLM's outputs. This validation loop (which may be executed in real time) guarantees that the LLM's responses remain anchored to verifiable data, thus eliminating/reducing the hallucinations and inaccuracies that have historically undermined trust in similar technologies.

In one or more implementations, the system can embed business rules, operational context, and/or industry-specific expertise into the generated narratives. These customizations may originate from stakeholder conversations that are distilled into reusable plain business language “snippets.” Such snippets are selectively merged into the output narratives, ensuring alignment with each organization's unique processes, metrics, and strategic goals. Consequently, the LLM's answers reflect the business-specific nuances and context essential for reasoning with enterprise data.

In one or more implementations, the system also provides data-query-to-narrative tools for delegating deterministic arithmetic—including aggregations and more complex calculations—to the underlying UDM database engine. Although LLMs can technically perform arithmetic, their probabilistic nature may introduce inaccuracies. By routing numerical computations through a deterministic data engine, the system ensures that all mathematical outputs remain traceable, reproducible, and correct, thereby mitigating the errors commonly associated with probabilistic language-based calculations.

In one or more implementations, the system may classify generated answers into three distinct tiers based on their verifiability within the UDM. Tier 1 (validated) comprises direct lookups from UDM rows, ensuring that each data point is fully traceable to a specific record. Tier 2 (reasoned & grounded) includes answers derived through operations on data elements that are entirely referenceable in the UDM; upon user request, the system displays the intermediate steps leading to the final conclusion. Tier 3 (All Other Responses) encompasses answers produced using inputs not entirely anchored in UDM rows—such as predictive forecasts, game-theory analyses, or combinations of incomplete data and inferential assumptions—thus indicating a lesser degree of direct verification.

### Computing Device

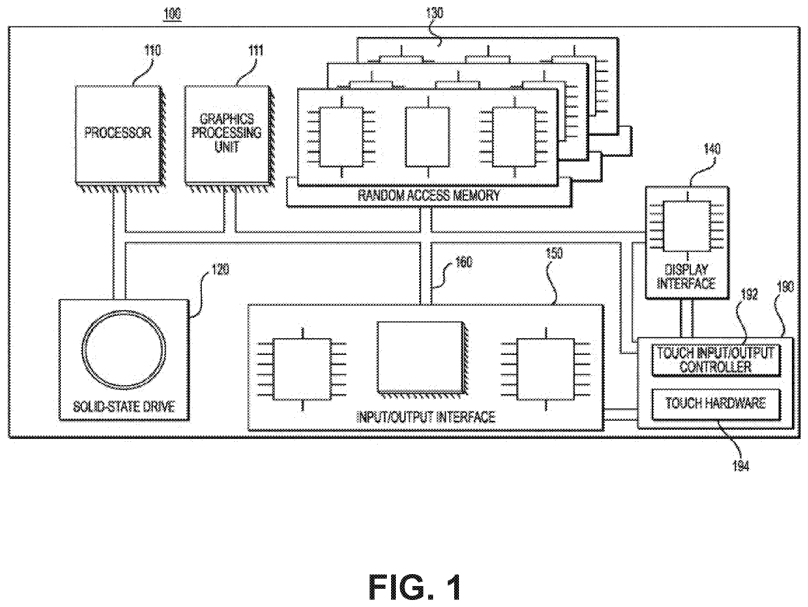

Referring to FIG. 1, there is shown a computing device 100 suitable for use with some implementations of the present technology, the computing device 100 comprising various hardware components including one or more single or multi-core processors collectively represented by processor 110, a graphics processing unit (GPU) 111, a solid-state drive 120, random-access memory 130, a display interface 140, and an input/output interface 150.

Communication between the various components of the computing device 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more implementations, the touchscreen 190 is the display. The touchscreen 190 may equally be referred to as a screen 190. In the implementations illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more implementations, the input/output interface 150 may be connected to a keyboard (not shown), a mouse (not shown), or a trackpad (not shown) allowing the user to interact with the computing device 100 in addition or in replacement of the touchscreen 190.

According to implementations of the present technology, the solid-state drive 120 stores program instructions suitable for being loaded into the random-access memory 130 and executed by the processor 110 and/or the GPU 111 for a system for enabling an LLM to reason with structured enterprise data. For example, the program instructions may be part of a library or an application.

The computing device 100 may be implemented as a server, a desktop computer, a laptop computer, a tablet, a smartphone, a personal digital assistant, or any device that may be configured to implement the present technology, as it may be understood by a person skilled in the art.

### System

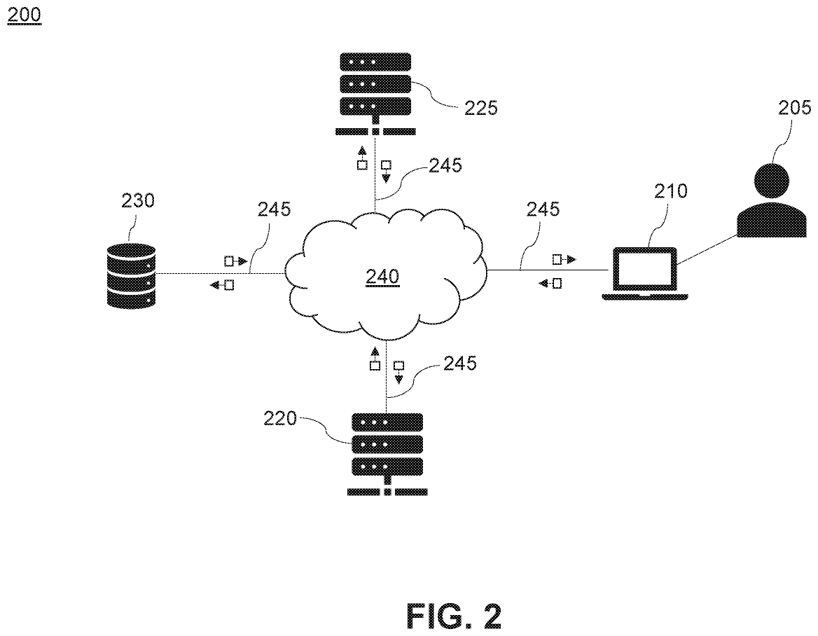

Referring to FIG. 2, there is shown a schematic diagram of a system 200, the system 200 being suitable for implementing one or more non-limiting implementations of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

In one or more implementations of the present technology, the system 200 is the system for enabling an LLM to reason with structured data, such as structured enterprise data. In one or more implementations of the present technology, the system 200 is part of the system for enabling an LLM to reason with structured enterprise data. In one or more implementations of the present technology, the system for enabling an LLM to reason with structured enterprise data is part of the system 200.

The system 200 comprises inter alia a client device 210 associated with a user 205, a first server 220, a second server 225 and a database 230 communicatively coupled over a communications network 240.

### Client Device

The system 200 comprises a client device 210. The client device 210 is associated with the user 205. As such, the client device 210 can sometimes be referred to as a “computing device”, “end user device”, or “client computing device”. It should be noted that the fact that the client device 210 is associated with the user 205 does not need to suggest or imply any mode of operation—such as a need to log in, a need to be registered, or the like. The client device 210 may be one particular device from amongst a plurality of client devices within the system 200.

The client device 210 comprises one or more components of the computing device 100 such as one or more single or multi-core processors collectively represented by the processor 110, the graphics processing unit (GPU) 111, the solid-state drive 120, the random-access memory 130, the display interface 140, and the input/output interface 150.

It will be appreciated that the client device 210 may be implemented as a server, a desktop computer, a laptop, a smartphone, and the like.

In one or more implementations, the client device 210 is configured to execute a browser application for the system for enabling an LLM to reason with structured data. The purpose of the given browser application is to enable the user of the system to access one or more web resources. How the given browser application is implemented is not particularly limited. Non-limiting examples of the given browser application that is executable by the client device 210 include Google™ Chrome™, Mozilla™ Firefox™, Microsoft™ Edge™, and Apple™ Safari™.

In one or more implementations, the user 205 may be an operator of the system for enabling an LLM to reason with structured enterprise data. The user 205 may be an agent (e.g., an artificial intelligence agent) or a bot carrying out the role of the operator. The user 205 may be a person using the client device 210 connected to the system for enabling an LLM to reason with structured enterprise data.

In one or more implementations, the client device 210 is configured for sending a question such as a business question to the server 220. The user 205 may input the question via a user interface of the client device 210.

### First Server

The first server 220 is configured to inter alia:
receive a question;
generate an initial query based on the question and sending the initial query to the LLM executed by the second server 225;
receive a data request from the LLM in response to the query;
process the data request to construct at least one model-specific query;
execute the at least one model-specific query against one or more authoritative sources of structured data, thereby obtaining a structured data result;
generate a contextual narrative based on the structured data result and sending the contextual narrative to the LLM;
receive a complete response to the initial query from the LLM; and
output the complete response.

How the first server 220 is configured to do so will be explained in more detail herein below.

It will be appreciated that the first server 220 can be implemented as a conventional computer server and may comprise at least some of the features of the computing device 100 shown in FIG. 1. In a non-limiting example of one or more implementations of the present technology, the first server 220 is implemented as a server running an operating system (OS). Needless to say that the first server 220 may be implemented in any suitable hardware and/or software and/or firmware or a combination thereof. In the disclosed non-limiting implementation of the present technology, the first server 220 is a single server. In one or more alternative non-limiting implementations of the present technology, the functionality of the first server 220 may be distributed and may be implemented via multiple servers (not shown).

The implementation of the first server 220 is well known to the person skilled in the art. However, the first server 220 comprises a communication interface (not shown) configured to communicate with various entities (such as the database 230 the client device 210 and the second server 225, for example, and other devices potentially coupled to the communication network 240) via the communication network 240. The first server 220 further comprises at least one computer processor (e.g., the processing device of the computing device 100) operationally connected with the communication interface and structured and configured to execute various processes to be described herein.

### Second Server

The second server 225 is configured to inter alia:
receive an initial query from the first server 220;
run an LLM to generate a data request in response to the query and transmit the data request to the first server 210; and
receive a contextual narrative in response to the data request;
generate, via the LLM, a complete response to the initial query based on the contextual narrative; and
transmit the complete response to the first server 210.

How the second server 225 is configured to do so will be explained in more detail herein below.

It will be appreciated that the second server 225 can be implemented as a conventional computer server and may comprise at least some of the features of the computing device 100 shown in FIG. 1. In a non-limiting example of one or more implementations of the present technology, the second server 225 is implemented as a server running an operating system (OS). Needless to say that the second server 225 may be implemented in any suitable hardware and/or software and/or firmware or a combination thereof. In the disclosed non-limiting implementation of the present technology, the second server 225 is a single server. In one or more alternative non-limiting implementations of the present technology, the functionality of the second server 225 may be distributed and may be implemented via multiple servers (not shown).

The implementation of the second server 225 is well known to the person skilled in the art. However, the second server 225 comprises a communication interface (not shown) configured to communicate with various entities (such as the first server 220, for example, and other devices potentially coupled to the communication network 240) via the communication network 240. The second server 225 further comprises at least one computer processor (e.g., the processing device of the computing device 100) operationally connected with the communication interface and structured and configured to execute various processes to be described herein.

### Database

A database 230 is communicatively coupled to the first server 220 and optionally to the client device 210 via the communications network 240 but, in one or more alternative implementations, the database 230 may be directly coupled to the first server 220 without departing from the teachings of the present technology. Although the database 230 is illustrated schematically herein as a single entity, it will be appreciated that the database 230 may be configured in a distributed manner; for example, the database 230 may have different components, each component being configured for a particular kind of retrieval therefrom or storage therein.

The database 230 may have stored thereon a structured collection of data, irrespective of its particular structure or the computer hardware on which data is stored, implemented or otherwise rendered available for use. The database 230 may reside on the same hardware as a processor that stores or makes use of the information stored in the database 230, or it may reside on separate hardware, such as on the first server 220. The database 230 may receive data from the server 220 for storage thereof and may provide stored data to the server 220 for use thereof.

In one or more implementations of the present technology, the database 230 is configured to store inter alia: structured data such as structured business or enterprise data.

### Communication Network

In one or more implementations of the present technology, the communications network 240 is the Internet. In one or more alternative non-limiting implementations, the communication network 240 may be implemented as any suitable local area network (LAN), wide area network (WAN), a private communication network, or the like. It will be appreciated that implementations for the communication network 240 are for illustration purposes only. How a communication link 245 (not separately numbered) between the client device 210, the first server 220, the second server 225, the database 230, and/or another computing device (not shown) and the communications network 240 is implemented will depend inter alia on how each computing device is implemented.

The communication network 240 may be used in order to transmit data packets amongst the different parts of the system 200. The communication network 240 may be used to transmit data such as requests and answers to requests between one or more components of the system 200. In another example, the communication network 240 may be used to transmit data between components of the same kind.

In one or more implementations, the second server 225 may be omitted so that the LLM resides on the first server 220.

### Overview of Technology for Enabling an LLM to Reason With Structured Data Such as Structured Enterprise Data

In at least one embodiment of the present technology, a system for enabling an LLM to reason with structured data is a protocol-based system for dynamically transforming structured data, such as structured enterprise data, from sources of data, such as authoritative sources, into reasoning narratives that enable an LLM to reason and answer questions. The system implements a comprehensive framework for the LLM to dynamically request facts during reasoning processes in natural language, while deterministically guaranteeing factual veracity with traceable lineage to eliminate hallucinations. This technical solution bridges the fundamental disconnect between structured data models and the text-based reasoning capabilities of LLMs.

In at least one embodiment of the present technology, a system for enabling an LLM to reason with structured data is a protocol-based system for dynamically transforming structured data, such as structured enterprise data, from authoritative sources (as defined herein) into reasoning narratives that enable an LLM to reason and answer questions. The system implements a comprehensive framework for the LLM to dynamically request facts during reasoning processes in natural language, while deterministically guaranteeing factual veracity with traceable lineage to eliminate hallucinations. This technical solution bridges the fundamental disconnect between structured data models and the text-based reasoning capabilities of LLMs.

In one or more implementations, the system provides a bidirectional communication protocol enabling the LLM to formulate and execute precise data requests during reasoning processes, while simultaneously establishing verification pathways for factual validation. The system implements a technical mechanism for translating natural language data requests into structured queries against authoritative data sources, with built-in verification parameters that track assertion provenance.

In one or more implementations, the system processes and executes these queries against appropriate data repositories based on request type, context, and access patterns, applying deterministic validation rules at each processing stage. Query results are returned in a format suitable for both transformation into natural language narratives and systematic fact verification, creating a closed-loop system where LLM assertions can be traced back to their authoritative data origins.

### Method for Enabling an LLM to Reason With Structured Enterprise Data

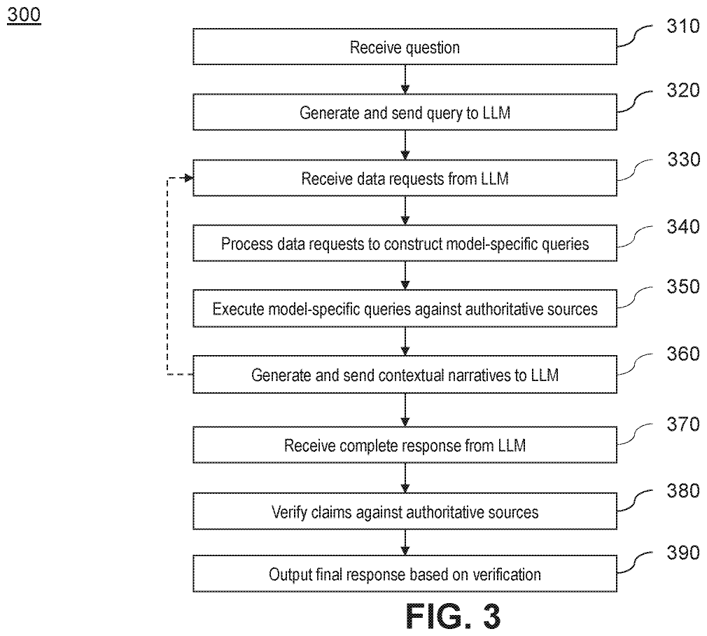

FIG. 3 depicts a flowchart of a method 300 for enabling a large language model (LLM) to reason with structured enterprise data in accordance with one or more non-limiting implementations of the present technology.

The method 300 is executed by a processing device operatively connected to a non-transitory computer readable storage medium, such as the processing device of the first server 220.

In one or more implementations, the first server 220 comprises a processing device such as the processor 110 and/or the GPU 111 operatively connected to a non-transitory computer readable storage medium such as the solid-state drive 120 and/or the random-access memory 130 storing computer-readable instructions. The processing device, upon executing the computer-readable instructions, is configured to or operable to execute the method 300.

According to processing step 310, the processing device receives a question such as a business question. The processing device may, for example, receive the question from at least one of a user interface, a user device such as user device 210, a server, or a remote device. The question may be formulated, for example, by a user, a bot, or an agent.

According to processing step 320, the processing device generates an initial query based on the received question and sends the initial query to the LLM such as to the second server 225. Sending the query to the LLM may cause the LLM to carry out an initial reasoning process on the query. When the question is a business question and prior to sending the query, the processing device may apply at least one of a business context and instructions to the business question to prepare the query.

In one or more implementations, the initial query comprises the received question in which context information has been inserted. In this case, the processing device is configured for enriching the received question with contextual information.

According to processing step 330, the processing device receives at least one data request from the LLM in response to the query. The data request generated by the LLM is indicative of data needed by the LLM to provide an answer to the query generated at step 320. The data requests provided by the LLM may be a result of its initial reasoning process. The data requests may be protocol-conformant. The data requests may follow a standardized protocol specification.

Protocol-conformant data request may include one or more of: a request type identifier; a data source identifier; query parameters; context requirements; and response format preferences.

According to processing step 340, the processing device processes the data requests received from the LLM to construct at least one model-specific query for data request. The processing device may utilize a data access system to process the data requests. The processing device may input the data requests through a universal data modeling interface with appropriate data model adapters (e.g., to construct the model-specific queries). The processing device may construct the model-specific queries from the data requests; the processing device may use the data model adapters to accomplish this.

According to processing step 350, the processing device executes the model-specific queries against one or more authoritative sources of structured data stored in the database 230 (e.g., authoritative data repositories containing structured data), thereby obtaining structured data results to the model-specific queries, i.e., an answer to a model-specific query contains specific data extracted from structured data. In one or more implementations, a structured data result may comprise data or information and an indication of a location source within the structured data from which the data or information has been extracted or found. The processing device may execute the model-specific queries against the authoritative data repositories using the data model adapters.

According to processing step 360, the processing device generates contextual narratives based on the structured data results and transmits the contextual narratives to the LLM. In one or more implementations, the contextual narratives may comprise fact verification embeddings (or embedded fact citations) associated with some piece of data or information extracted from the structured data. Fact verifications may be inserted into contextual narratives in the form of metadata. For example, a fact verification embedding associated with a given information contained in a contextual narrative may be indicative of the source/location (such as the entry, row, record, etc.) where the information was found in the structured data. Sending the contextual narratives to the LLM may cause the LLM to incorporate the contextual narratives into a subsequent reasoning process to generate a complete response to the initial query. One of the purposes of this may be to facilitate accurate transitioning from tabular data to text. According to processing step 340, the processing device processes the data requests received from the LLM to construct at least one model-specific query for each data request. As used herein, a model-specific query is a query constructed in the native query language or access pattern of a particular data model (e.g., a SQL query for a relational model, a Cypher query for a graph model, or a path expression for a hierarchical model), as distinguished from the protocol-conformant data request, which is model-agnostic. The processing device may utilize a data access system to process the data requests. The processing device may input the data requests through a universal data modeling interface with appropriate data model adapters. As used herein, the universal data modeling interface is an abstraction layer that receives model-agnostic, protocol-conformant data requests and routes them to the appropriate data model adapter for the target data source, providing a consistent application programming interface (API) for data access regardless of the underlying data model. As used herein, a data model adapter is a specialized component that translates protocol-conformant data requests into model-specific queries for a particular data modeling paradigm and facilitates execution of those queries against the corresponding authoritative source (e.g., a relational model adapter translates requests into SQL queries against normalized tables, a dimensional model adapter handles star or snowflake schemas, and a graph model adapter handles property graphs with nodes and edges). The processing device may construct the model-specific queries from the data requests; the processing device may use the data model adapters to accomplish this.

Prior to sending the contextual narratives, the processing device may transform the structured data results into the contextual narratives using a narrative transformation engine. This transformation may be dynamic. The processing device may maintain bidirectional mappings between the structured data and the contextual narratives during this transformation. Prior to sending the contextual narratives, the processing device may transform the structured data results into the contextual narratives using a narrative transformation engine. This transformation may be dynamic. The processing device may maintain bidirectional mappings between the structured data and the contextual narratives during this transformation. As used herein, a bidirectional mapping is a data structure or set of associations that preserves a two-way linkage between elements in the structured data and their corresponding representations in the contextual narrative, enabling both forward tracing (from a source data element to its narrative representation) and backward tracing (from a narrative representation back to the specific source data element from which it was derived). Bidirectional mappings enable the system to reconstruct structured queries from narrative content and to verify claims in the LLM's response by tracing them back to their authoritative data origins.

The transformation of the structured data results into contextual narratives may vary based on the underlying data model:
for relational/entity-relationship models, narratives may be constructed by describing entity attributes and their relationships, traversing join paths to create coherent stories about related entities with temporal aspects derived from timestamp fields;
for dimensional models, narratives may describe metrics in the context of their dimensions, with appropriate business terminology derived from dimension attributes and hierarchical dimensions represented with appropriate levels of detail;
for data vault models, narratives may traverse hub-link-satellite structures to create temporally accurate descriptions that respect the historical tracking inherent in the data vault model, clearly indicating point-in-time accuracy;
for hierarchical models, narratives may follow parent-child relationships to build structured narratives that preserve the hierarchical context and clearly articulate relationships between levels;
for graph models, narratives may emphasize relationships between entities by traversing nodes and edges, incorporating properties of both nodes and edges, and preserving path information to show how entities are connected through complex networks;
for semantic layers, narratives may leverage business-friendly terminology and relationships defined in the semantic layer, explaining calculated metrics and key performance indicators (KPIs) in business terms with their derivation logic incorporated into the narrative.

Optionally, the processing device may iterate through processing steps 330 to 360, as the LLM identifies additional information requirements. Once it has determined that it has sufficient information to provide a complete response to the initial query, the LLM stops sending data requests and generates and transmits a complete response to the initial query. However, as long as it determines that additional information is required to generate the complete response, steps 330-360 are repeated.

According to processing step 370, the processing device receives a complete response to the query from the LLM. The complete response may be based on the subsequent reasoning process applied to the contextual narratives. As the complete response is obtained from the LLM, it may be considered to be a complete, “reasoned” response.

According to processing step 380, the processing device verifies claims made in the complete response against the one or more authoritative sources, and may optionally generate categorizations of each of the claims that were verified. This verification of claims may be based on the fact verification embeddings inserted in the contextual narratives. In this case, the LLM was previously instructed to insert the received fact verification embeddings into its complete response to the initial query. For example, if the complete response comprises a fact verification embedding associated with an information or data and the fact verification embedding is indicative of a source within the structured data from which the information or data was extracted at step 350, the processing device may access the source of structured data to verify that the data or information contained in this source corresponds to the information or data contained in the complete response. If so, the processing device determines that the information or data has been verified.

In one or more implementations, the purpose of this verification may be to deterministically verify that whatever is ultimately output (e.g., to a user that formulated the business question at the outset) is correct. The categorization of the claims that have been verified may comprise categorizing each of the claims as being correct and/or having been reasoned (but not verified). This verification of claims may include generating an audit trail made in verifying the claims. In one or more implementations, the purpose of this verification may be to deterministically verify that whatever is ultimately output (e.g., to a user that formulated the business question at the outset) is correct. The categorization of the claims that have been verified may comprise categorizing each of the claims as being correct and/or having been reasoned (but not verified). This verification of claims may include generating an audit trail made in verifying the claims. As used herein, an audit trail is a structured record that documents the verification process, comprising for each claim: an identification of the claim extracted from the LLM's response, a record of how the claim was verified against the one or more authoritative sources (including any verified queries executed and their results), the verification outcome for the claim (e.g., verified, partially verified, or unverified), and data lineage information tracing the claim back to the specific source data from which it was derived. The audit trail provides transparency and reproducibility of the verification outcome and may be used in generating the final response.

The processing device may verify the claims against the authoritative sources using model-appropriate verification methods applied to the claims as related to the model-specific queries. Prior to verifying the claims, the processing device may extract the claims from the complete response for verification. After verifying the claims, the processing device may classify each of the claims that were verified according to a verification framework that categorizes content within the claims that were verified into specific verification tiers. The processing device may attach the fact verification embeddings to corresponding content elements for each of the claims that were verified.

The verification process may adapt to different data models using specialized verification strategies including:
for relational models, constructing SQL queries with appropriate joins to confirm facts;
for dimensional models, querying fact tables with appropriate dimension filters;
for data vault models, including temporal context in verified queries to access appropriate satellite records;
for hierarchical models, following hierarchical paths to confirm parent-child relationships;
for graph models, using path traversals and pattern matching to confirm relationships;
for semantic layers, translating business terminology into underlying technical implementations.

According to processing step 390, the processing device outputs a final response based on the complete response and the categorizations. In one or more implementations, the final response to the initial query comprises the complete response received from the LLM in which verification indications are inserted to inform the user whether an information, a data or a claim contained in the final response has been verified or not.

The final response may also be based on the audit trail and/or other aspects of the verification of the claims. The processing device may output the final response by, for example: storing the final response into memory, transmitting the final response to a user device such as user device 210, displaying the final response on a user interface; displaying the final response on a user device; sending the final response to a server to cause the final response to be output to a computing device connected to the server; or displaying the final response on a remote device.

The method 300 then ends.

In one or more implementations, the step 380 is omitted from the method 300. In this case, the final response outputted at step 390 corresponds to the complete response received from the LLM at step 370. It will be understood that, in this case, there may be no insertion of fact verification embeddings at step 360.

In at least one implementation, the method 300 is performed in a different order. In at least one implementation, the method 300 is performed in such a manner that some or all of the steps are carried out iteratively.

In at least one embodiment, a first modified method for enabling an LLM to reason with structured enterprise data comprises only some of the steps in method 300. In such a case, the first modified method may replace some of the missing steps with other steps to further achieve the goals of the present technology.

In at least one embodiment, a second modified method for enabling an LLM to reason with structured enterprise data comprises all of the steps in method 300, as well as one or more additional steps. In such a case, the second modified method may add steps to further achieve the goals of the present technology.

In at least one embodiment, a non-transitory computer-readable medium (CRM) has stored thereon computer-executable instructions that, when executed by at least one processor, cause the at least one processor to perform the method 300. The CRM may also have stored thereon additional computer-executable instructions, such as those of any of the implementations of method 300 discussed herein.

In at least one embodiment, a system for enabling an LLM to reason with structured enterprise data according to method 300 comprises a processor and a non-transitory computer-readable medium have stored thereon computer-executable instructions. The computer-executable instructions, when run by the processor, cause the processor to execute the method 300. The system may also have additional features, such as those of any of the implementations of method 300 discussed herein. The system may also have additional features, such as those of any of the components and/or modules described herein.

### Workflow for Enabling an LLM to Reason With Structured Enterprise Data

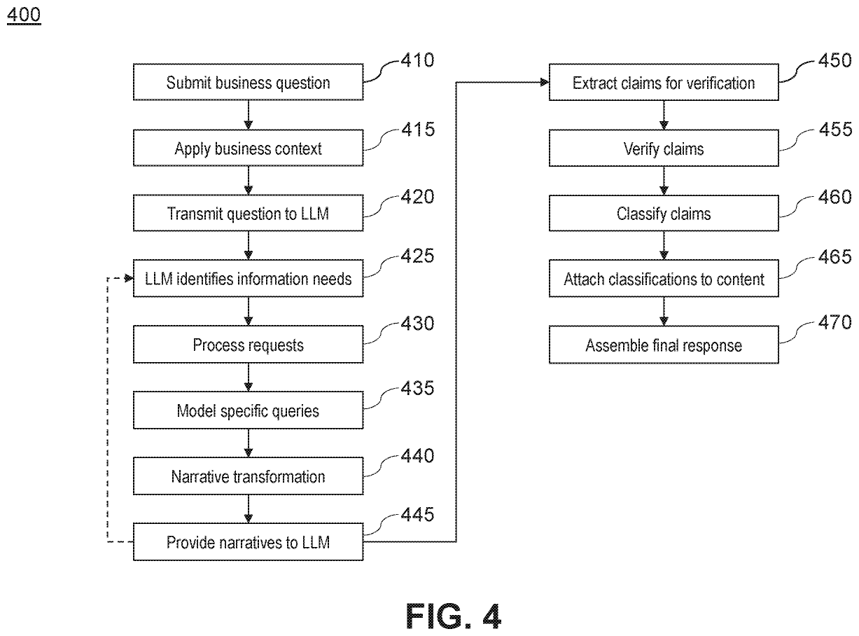

FIG. 4 depicts a flowchart of a technical workflow 400 for enabling a large language model (LLM) to reason with structured enterprise data in accordance with one or more non-limiting implementations of the present technology.

The workflow 400 may be implemented using some or all of the computing device 100 and/or system 200. The workflow 400 may be combined in part or in whole with some or all of the method 300.

The workflow 400 begins at step 410.

According to step 410, a user submits a business question through the interface component.

According to step 415, the system optionally applies business context and instructions to enrich the question.

According to step 420, the question is transmitted to the LLM for initial reasoning processing.

According to step 425, during reasoning, the LLM identifies information needs and generates protocol-conformant data requests.

According to step 430, the data access system processes these requests, routing them to the appropriate data model adapter.

According to step 435, the adapter constructs and executes model-specific queries against the authoritative structured data repository.

According to step 440, retrieved structured data is processed by the narrative transformation engine into contextual narratives.

According to step 445, these narratives are provided to the LLM, which incorporates them into its reasoning process.

Optionally, steps 425 to 445 may occur iteratively as the LLM identifies additional information requirements.

According to step 450, upon generating a complete response, the assertion verification system extracts claims for verification.

According to step 455, each claim is verified against authoritative sources using model-appropriate verification methods.

According to step 460, claims are classified according to the verification framework.

According to step 465, the verification classification is attached to corresponding content elements.

According to step 470, the final response is assembled with verification metadata and presented to the user.

The workflow 400 then ends.

### Reasoning Narrative Construction

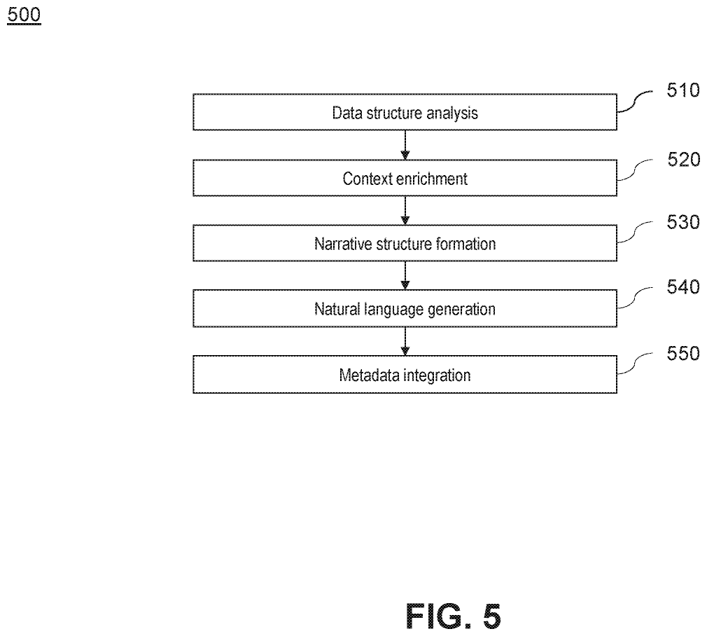

FIG. 5 depicts a schematic diagram of software modules 500 for a system for enabling an LLM to reason with structured enterprise data in accordance with one or more non-limiting implementations of the present technology. The software modules 500 may be implemented using some or all of the computing device 100 and/or system 200. One or more of the software modules 500 may be used to execute the method 300 and/or the workflow 400.

The software modules 500 provide the ability to construct reasoning narratives from structured data across different data modeling approaches. The software modules 500 may be considered to have interdependent functionality. Alternatively, or in addition, the software modules 500 may provide the steps at a high level to construct reasoning narratives. The software modules 500 include: data structure analysis 510, context enrichment 520, narrative structure formation 530, natural language generation 540, and metadata integration 550. The software modules 500 may be executed in order as shown or in a different order in order to accomplish the goals of the present technology.

### 1. Data Structure Analysis 510:

Entity identification and classification;
Relationship mapping and typing;
Attribute categorization and prioritization;
Temporal sequence detection; and
Hierarchical structure recognition.

### 2. Context Enrichment 520:

Business rule application based on metadata;
Relationship contextualization with domain knowledge;
Temporal context addition (point-in-time, sequence, duration);
Domain terminology integration from glossaries or ontologies; and
Contextual significance assessment based on usage patterns.

### 3. Narrative Structure Formation 530:

Template selection based on data patterns and relationships;
Narrative flow planning with appropriate causal connections;
Detail level determination based on significance and relevance;
Section organization for complex multi-entity narratives;
Contextual framing to establish narrative perspective.

### 4. Natural Language Generation 540:

Syntactic structure formation appropriate to content type;
Terminology selection from domain-specific vocabularies;
Connective phrase insertion for narrative coherence;
Entity reference management for clarity and consistency;
Temporal expression normalization for readability.

### 5. Metadata Integration 550:

Source data linkage with bidirectional references;
Verification status tagging at appropriate granularity;
Confidence indication based on data quality and provenance;
Lineage tracking for complex derived statements;
Context reference preservation for subsequent verification.

The specific implementation of these steps may vary based on the underlying data model, with specialized algorithms for each model type. The system identifies the appropriate strategy based on data source metadata and applies the corresponding transformation logic.

The resulting narratives may preserve the semantic richness of the original structured data while presenting it in a natural language format that LLMs can effectively reason with. This bidirectional transformation may enable LLMs to both consume structured data as text and produce outputs that can be verified against the original structured sources.

### Technical Components and Architecture

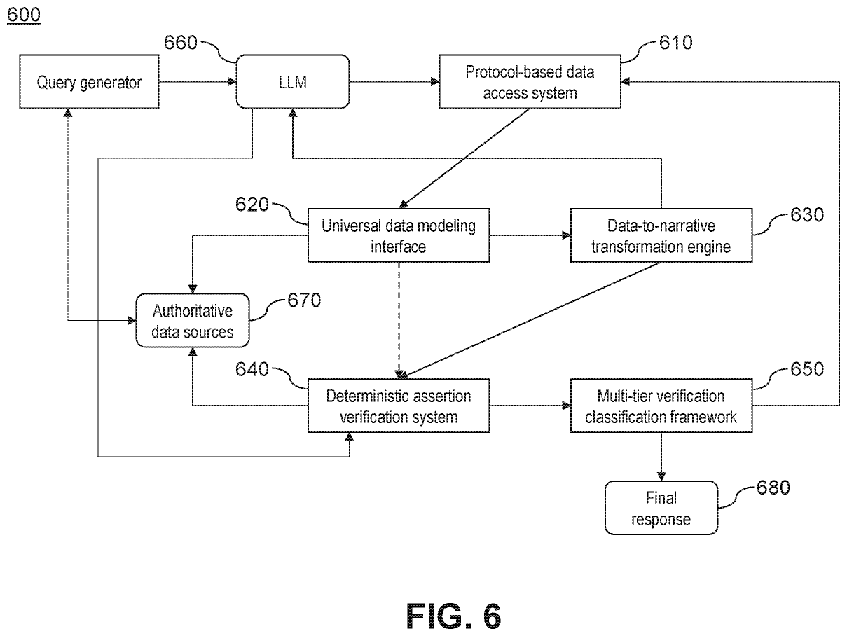

FIG. 6 depicts a schematic diagram of a software architecture 600 for a system for enabling an LLM to reason with structured enterprise data in accordance with one or more non-limiting implementations of the present technology. The software architecture 600 may be implemented using some or all of the computing device 100 and/or system 200. The software architecture 600 may be used to carry out some or all of the method 300 and/or the workflow 400, and/or execute one or more of the software modules 500.

The software architecture 600 comprises several interconnected components that function in a coordinated manner. The components include a query generator 605, a protocol-based data access system 610, a universal data modeling interface 620, a data-to-narrative transformation (or narrative transformation) engine 630, a deterministic assertion verification system 640, and a multi-tier verification classification system 650.

### 1. Query Generator

The query generator 605 is configured for receiving a question such as a business question, generating an initial query based on the received question and transmitting the initial query to the LLM 660. In one or more implementations, the initial query substantially corresponds to the received question. In other implementations, the initial query corresponds to the received question enriched with contextual information. In this case, the query generator 605 is further configured for enriching the received question with contextual information.

### 2. Protocol-Based Data Access System

The protocol-based data access system 610 implements a standardized protocol for LLMs to request data during reasoning. This protocol captures the LLM's data needs and transforms them into appropriate queries for backend structured data systems. The protocol-based data access system 610 may therefore receive and process standardized data requests from an LLM during reasoning processes and transform the requests into structured queries for backend structured data systems. The protocol may define:
A structured format for data requests, including request type, parameters, and context requirements;
Mechanisms for routing requests to appropriate data access controllers;
Standardized response formats that include both the requested data and metadata (e.g., provenance metadata) for verification;
Error handling protocols for various exception conditions.

In one or more implementations, the protocol-based data access system 610 intercepts specially tagged outputs from the LLM that conform to the protocol specification. A parser extracts request parameters, target data sources, and contextual requirements. The request is then routed to appropriate data access controllers that interface with underlying data stores. Results are returned with complete provenance information for downstream processing.

In at least one implementation, the protocol-based data access system 610 executes one or more of the following operations:
Receive data requests from an LLM 660;
Send standardized queries to the universal data modeling interface 620.

### 3. Universal Data Modeling Interface

The universal data modeling interface 620 allows the present technology to work with multiple enterprise data modeling approaches through a universal interface layer. This layer abstracts the specific implementation details of different data models, providing a consistent application programming interface (API) for data access regardless of the underlying structure. The universal data modeling interface 620 may therefore provide a consistent API across multiple enterprise data modeling approaches through specialized adapters. The system may support various data modeling paradigms through specialized adapters such as:
Relational/Entity-Relationship Model adapter that translates requests into SQL queries against normalized tables;
Dimensional Model adapter optimized for star or snowflake schemas with facts and dimensions;
Data Vault adapter that handles the hub-link-satellite pattern of data vault architecture;
Hierarchical/Network Model adapter for legacy systems with parent-child relationships;
Graph Model adapter for property graphs with nodes and edges;
Object-Oriented Model adapter supporting objects with attributes and behaviors;
Document-Oriented/NoSQL Model adapter for semi-structured document collections;
Columnar Model adapter optimized for column-oriented storage formats; and/or
Semantic Layer adapter that works with business-friendly abstract data models.

Each adapter implements a common interface while handling the specific query patterns, join logic, and traversal mechanisms appropriate for its target data model. The universal data modeling interface 620 ensures the system can be deployed across diverse enterprise environments with different data architectures.

In at least one implementation, the universal data modeling interface 620 executes one or more of the following operations:
Receive queries from the protocol-based data access system 610;
Interface with authoritative data sources 670;
Send structured data to the data-to-narrative transformation engine 630;
Provide verification query capabilities to the deterministic assertion verification system 640.

### 4. Data-to-Narrative Transformation Engine

The data-to-narrative transformation engine 630 converts structured query results into contextually rich natural language narratives suitable for LLM consumption. The data-to-narrative transformation engine 630 may preserve data relationships, temporal aspects, business rules, and business process context during the conversion process. It maintains bidirectional traceability between narrative elements and source records, enabling later verification.

The data-to-narrative transformation engine 630 may therefore be a bidirectional narrative transformation component that converts structured query results into contextually rich natural language narratives for LLM consumption while maintaining complete semantic mappings between source data and narrative elements. The bidirectional narrative transformation component may, for example:
maintain complete semantic integrity during transformations in both directions;
encode business rules, relationship context, temporal context, and domain terminology in generated narratives;
embed business process context and temporal sequence information within narrative structures;
preserve hierarchical relationships and entity associations in a reversible manner; and/or
establish bidirectional traceability between narrative elements and source records that enables reconstruction of source queries from narrative content.

The transformation process may follow a multi-stage pipeline:
Data Structure Analysis: The system analyzes the structure of the retrieved data, identifying entity relationships, temporal sequences, hierarchical structures, and data types.
Context Enrichment: Business rules, relationship context, temporal context, and domain terminology are applied to enrich the raw data with relevant business meaning.
Narrative Template Selection: Appropriate narrative templates are selected based on the data structure, context, and intended use. These templates provide the structural framework for the generated narratives.
Natural Language Generation: The enriched data is transformed into natural language text following the selected templates, with appropriate syntactic structures, terminology, and narrative flow.
Metadata Embedding: References to source data, verification status, confidence indicators, and context references are embedded in the generated narrative, enabling traceability and verification.

The implementation of the data-to-narrative transformation engine 630 may vary based on the underlying data model:
For relational models, it navigates join relationships to build coherent narratives across tables;
For dimensional models, it constructs narratives that explain metrics in context of their dimensions;
For data vault models, it traverses hub-link-satellite structures to create temporally accurate narratives;
For hierarchical models, it follows parent-child relationships to build structured, hierarchical narratives;
For graph models, it traverses node and edge relationships to capture interconnected entity narratives;
For object-oriented models, it leverages object attributes and behaviors for comprehensive descriptions;
For document models, it extracts and organizes document fields into contextually relevant narratives;
For columnar models, it rebuilds row context from optimized columnar storage; and/or
For semantic layers, it utilizes business metadata to create business-friendly narrative descriptions.

In at least one implementation, the data-to-narrative transformation engine 630 executes one or more of the following operations:
Transform structured data into natural language narratives;
Sends narratives to both the LLM 660 and the deterministic assertion verification system 640; and/or
Maintain bidirectional traceability between data and text.

### 5. Deterministic Assertion Verification System

The deterministic assertion verification system 640 validates statements generated by the LLM against authoritative data sources (through verified queries), implementing mechanisms to extract verifiable claims and classify them according to verification level. The deterministic assertion verification system 640:
1. Extracts claims from LLM outputs through syntactic parsing for example;
2. Transforms natural language claims into structured verification queries;
3. Executes these queries against authoritative data sources;
4. Compares results to determine verification status;
5. Classifies each claim according to its verification level; and/or
6. Provides feedback for correction or flagging of unverified content.

The deterministic assertion verification system 640 can leverage external pre-existing verified queries, which are syntactically validated and semantically confirmed database queries that provide deterministic verified results even when direct fact referencing is not possible. These verified queries:
1. Are looked up and referenced (or generated and validated) during the data retrieval process;
2. Include complete provenance information (query ID, parameters, result structures);
3. Maintain a complete audit trail between assertions and their data sources; and/or
4. Enable Tier 1 verification even in complex data models where direct record referencing is impractical.

The verification system accommodates different data models through specialized verification strategies:
For relational models, it constructs precise SQL queries to verify specific facts;
For dimensional models, it verifies facts against appropriate fact and dimension tables;
For data vault models, it considers temporal context when verifying historical facts;
For hierarchical models, it traverses hierarchies to confirm relationships and attributes;
For graph models, it validates relationships through path traversals and node properties;
For object-oriented models, it verifies facts against object attributes and relationships;
For document models, it checks assertions against relevant document fields;
For columnar models, it reconstructs necessary contexts for verification; and/or
For semantic layers, it translates business terminology into technical queries for verification.

In at least one implementation, the deterministic assertion verification system 640 executes one or more of the following operations:
Verify claims against authoritative data sources 670;
Work with both the universal data modeling interface 620 and data sources; and/or
Send verified claims to the multi-tier verification classification framework 650.

### 6. Multi-Tier Verification Classification Framework

The multi-tier verification classification framework 650 implements a structured classification system for generated content based on verification level. This framework enables clear communication of verification status to end users and supports differentiated handling of content based on verification tier. The multi-tier verification classification framework 650 may therefore consistently categorize generated content based on verification level.

The classification system may define several verification tiers:
Tier 1 (Validated): Statements derived from authoritative structured data sources with complete traceability through verified queries. These statements can be deterministically verified through either:
Direct 1:1 mapping to specific source records with complete provenance information, or
Execution of verified queries that deterministically produce the same result, ensuring verification even when direct record references are not available.

The verified query mechanism ensures Tier 1 validation is possible across diverse data models, including those where direct record referencing is impractical.
Tier 2 (Reasoned & Grounded): Statements derived through logical operations on validated data elements. All input data elements are Tier 1 validated (through either direct reference or verified queries), but transformation operations have been applied. The complete reasoning chain, including any intermediate verified queries, is available for inspection. The transformation operations may be limited to mathematical calculations, aggregation functions, categorical groupings, or logical operators applied to Tier 1 validated data elements.
Tier 3 (Inferred Insights): Statements that incorporate elements not directly traceable to authoritative data through either record references or verified queries. These may include predictive, hypothetical, or reasoned extensions beyond available data, with explicit uncertainty indicators. The statements may (i) employ probabilistic reasoning or statistical inference methods, (ii) extend beyond available data through predictive modeling, hypothetical scenarios, or pattern-based extrapolation, and/or (iii) contain any component that cannot be classified as either Tier 1 or Tier 2. The Tier 3 content may include explicit uncertainty indicators and confidence metrics where applicable.

In one or more implementations, the classification system may attach verification metadata to individual content elements, enabling visualization through indicators, color coding, or explicit labels. User interfaces can adapt based on the verification status of presented information.

The multi-tier verification classification framework 650 may further comprise a boundary case resolution component that implements a deterministic classification methodology for content with mixed verification characteristics. The boundary case resolution component may use one or more of the following rules:
statements containing any element not meeting Tier 1 or Tier 2 criteria are automatically classified as Tier 3;
composite statements are classified according to their lowest-tier component;
transformation operations are evaluated against a predefined registry of approved operations for Tier 2 classification; and/or
verification confidence score is calculated and attached to each statement to indicate relative position within its assigned tier.

In at least one implementation, the multi-tier verification classification framework 650 may execute one or more of the following operations:
Classify verified claims into appropriate tiers;
Provide feedback to improve future queries of the protocol-based data access system 610; and/or
Produce the final verified response 680.

### Method for Implementing a Protocol-Based Data Transformation System for an LLM

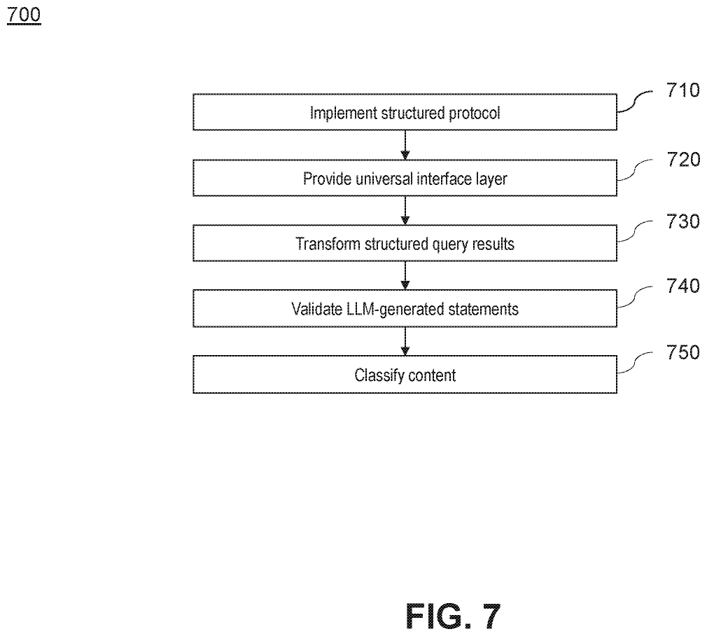

FIG. 7 depicts a flowchart of a method 700 for implementing a protocol-based data transformation system for a large language model (LLM) in accordance with one or more non-limiting implementations of the present technology.

The method 700 may be implemented using some or all of the computing device 100 and/or system 200. The method 700 may be used in conjunction with some or all of the method 300, the workflow 400, the software modules 500, and/or the software architecture 600.

The method 700 begins at processing step 710.

According to processing step 710, the processing device implements a structured protocol that enables LLMs to request specific data during reasoning processes by specifying request types, parameters, and context requirements. The processing device may implement the structured protocol using, for example, the protocol-based data access system 610.

According to processing step 720, the processing device provides a universal interface layer that abstracts different data modeling approaches through specialized adapter components. The processing device may provide the universal interface layer using, for example, the universal data modeling interface 620.

According to processing step 730, the processing device transforms structured query results into natural language narratives for LLM consumption while maintaining bidirectional traceability. The processing device may transform the structured query results using, for example, the data-to-narrative transformation engine 630.

According to processing step 740, the processing device validates LLM-generated statements against authoritative data sources using verified queries. The processing device may validate the LLM-generated statements using, for example, the deterministic assertion verification system 640.

According to processing step 750, the processing device classifies content based on a multi-tier verification framework that consistently categorizes statements by their verification level. The processing device may classify the content using, for example, the multi-tier verification classification system 650.

The method 700 then ends.

In at least one implementation, the method 700 further comprises implementing verified queries that (i) are syntactically validated and semantically confirmed; (ii) embed complete provenance information; (iii) are persistent alongside generated narrative content; and/or (iv) can be re-executed to validate assertions at any point.

In at least one implementation, the method 700, further comprises: (i) attaching verification metadata to individual content elements, the metadata including both the assigned verification tier and a confidence score indicating relative positioning within the tier; (ii) enabling visualization of verification status through indicators, color coding, or explicit labels that clearly differentiate between verification tiers and highlight boundary cases through gradient indicators or explicit boundary case designations; and/or (iii) adapting user interfaces based on the verification status of presented information, including specialized interface elements for content near tier boundaries to communicate verification limitations.

In at least one implementation, the method 700 is performed in a different order. In at least one implementation, the method 700 is performed in such a manner that some or all of the steps are executed iteratively.

In at least one embodiment, a first modified method for implementing a protocol-based data transformation system for an LLM comprises only some of the steps in method 700. In such a case, the first modified method may replace some of the missing steps with other steps to further achieve the goals of the present technology.

In at least one embodiment, a second modified method for implementing a protocol-based data transformation system for an LLM comprises all of the steps in method 700, as well as one or more additional steps. In such a case, the second modified method may add steps to further achieve the goals of the present technology.

In at least one embodiment, a non-transitory computer-readable medium (CRM) has stored thereon computer-executable instructions that, when executed by at least one processor, cause the at least one processor to perform the method 700. The CRM may also have stored thereon additional computer-executable instructions, such as those of any of the implementations of method 700 discussed herein.

In at least one embodiment, a system for implementing a protocol-based data transformation system for an LLM comprises a processor and a non-transitory computer-readable medium have stored thereon computer-executable instructions. The computer-executable instructions, when run by the processor, cause the processor to carry out method 700. The system may also have additional features, such as those of any of the implementations of method 700 discussed herein. The system may also have additional features, such as those of any of the components and/or modules described herein.

### Method for Enabling Bidirectional Communication Between LLMs and Structured Data Sources

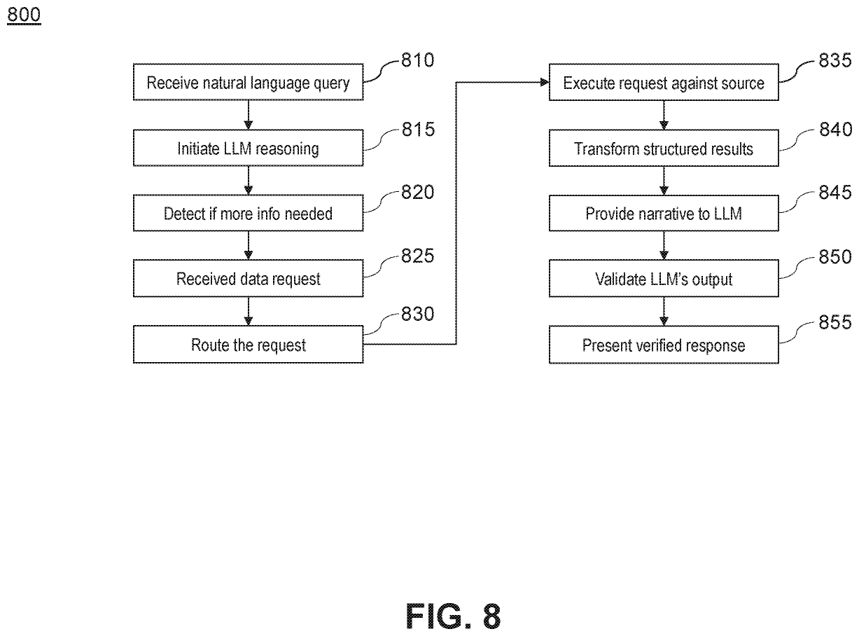

FIG. 8 depicts a flowchart of a method 800 for enabling bidirectional communication between a large language model (LLM) and one or more structured data sources in accordance with one or more non-limiting implementations of the present technology.

The method 800 may be implemented using some or all of the computing device 100 and/or system 200. The method 800 may be used in conjunction with some or all of the method 300, the workflow 400, the software modules 500, the software architecture 600, and/or the method 700.

The method 800 begins at processing step 810.

According to processing step 810, the processing device receives a natural language query/question from a user through a user interface component.

According to processing step 815, the processing device initiates LLM reasoning on the query by transmitting the query to the LLM.

According to processing step 820, the processing device detects when the LLM requires additional information to continue its reasoning process.

According to processing step 825, the processing device receives a structured data request from the LLM that conforms to a predefined protocol specification.

According to processing step 830, the processing device routes the request to an appropriate data adapter based on the data model of the target source.

According to processing step 835, the processing device executes the request against an authoritative data source to retrieve structured data.

According to processing step 840, the processing device transforms the structured results into a natural language narrative that preserves business context, relationships, and temporal aspects.

According to processing step 845, the processing device provides the narrative to the LLM to continue its reasoning process.

According to processing step 850, the processing device validates the LLM's output statements against source data using verified queries.

According to processing step 855, the processing device presents the verified response to the user with appropriate verification indicators that communicate the verification status of different content elements.

The method 800 then ends.

In at least one implementation of the method 800, the processing device validates the LLM's output statements by: (i) implementing verified queries that contain the exact query, parameters, and execution context used to retrieve the original data; (ii) persisting these verified queries alongside the narrative content they generate to maintain provenance; (iii) establishing an immutable audit trail between assertions made by the LLM and their underlying data sources; and/or (iv) enabling re-execution of verified queries to validate assertions at any point without requiring direct record references.

In at least one implementation, the method 800 is performed in a different order. In at least one implementation, the method 800 is performed in such a manner that some or all of the steps are carried out iteratively.

In at least one embodiment, a first modified method for enabling bidirectional communication between an LLM and one or more structured data sources comprises only some of the steps in method 800. In such a case, the first modified method may replace some of the missing steps with other steps to further achieve the goals of the present technology.

In at least one embodiment, a second modified method for enabling bidirectional communication between an LLM and one or more structured data sources comprises all of the steps in method 800, as well as one or more additional steps. In such a case, the second modified method may add steps to further achieve the goals of the present technology.

In at least one embodiment, a non-transitory computer-readable medium (CRM) has stored thereon computer-executable instructions that, when executed by at least one processor, cause the at least one processor to perform the method 800. The CRM may also have stored thereon additional computer-executable instructions, such as those of any of the implementations of method 800 discussed herein.

In at least one embodiment, a system for enabling bidirectional communication between an LLM and one or more structured data sources comprises a processor and a non-transitory computer-readable medium have stored thereon computer-executable instructions. The computer-executable instructions, when run by the processor, cause the processor to execute the method 800. The system may also have additional features, such as those of any of the implementations of method 800 discussed herein. The system may also have additional features, such as those of any of the components and/or modules described herein.

### Preserving Business Context in Data Transformations for LLM Reasoning

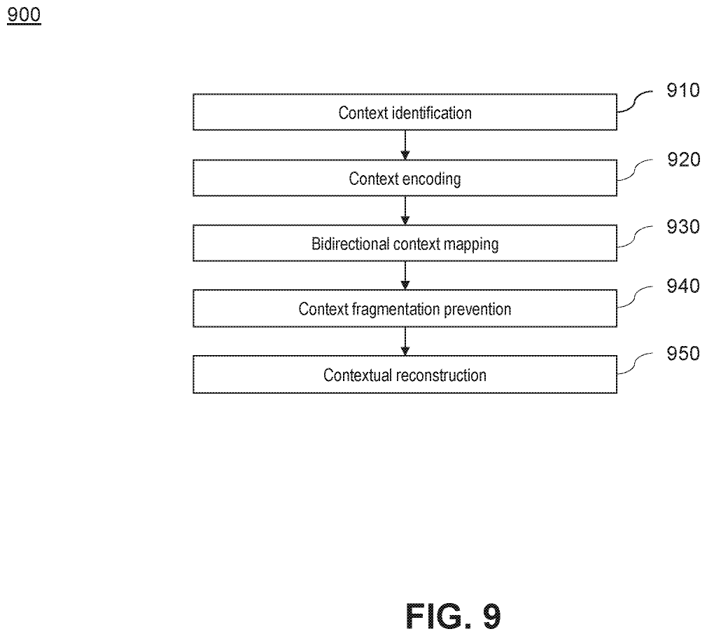

FIG. 9 depicts a schematic diagram of software components 900 for a system for preserving business context in data transformations for large language model (LLM) reasoning in accordance with one or more non-limiting implementations of the present technology. The software components 900 may be implemented using some or all of the computing device 100 and/or system 200. The software components 900 may be used in conjunction with some or all of the method 300, the workflow 400, the software modules 500, the software architecture 600, the method 700, and/or the method 800.

The software components 900 provide the ability to preserve business context in data transformations for LLM reasoning. The software components 900 may be considered to have interdependent functionality. Alternatively, or in addition, the software components 900 may provide the steps at a high level to preserve business context in data transformations for LLM reasoning. The software components 900 include: context identification component 910; context encoding mechanism 920; bidirectional context mapping engine 930; context fragmentation prevention mechanism 940; contextual reconstruction component 950. The software components 900 may be executed in order as shown or in a different order in order to accomplish the goals of the present technology.

The context identification component 910 is configured to analyze source data structures and extract contextual information including business rules, entity relationships, temporal aspects, and domain-specific meanings.

The context encoding mechanism 920 embeds extracted contextual information within generated narratives through syntactic structures, specialized terminology, relationship articulation, and metadata such as in the initial query and/or the contextual narratives generated in response to the LLM requests.

The bidirectional context mapping engine 930 maintains a reversible transformation between structured data elements and narrative components. The bidirectional context mapping engine 930 may: (i) maintain associations between individual data elements and their narrative representations; (ii) preserve the business significance of relationships between entities; (iii) encode temporal context including point-in-time accuracy, sequences, and durations; and/or (iv) incorporate domain terminology and business rules that define semantic meaning beyond raw data.

The context fragmentation prevention mechanism 940 ensures semantic integrity during transformations.

The contextual reconstruction component 950 regenerates structured queries from narrative content with preserved business context.

### Method for Maintaining Context Integrity in Bidirectional Data Transformations

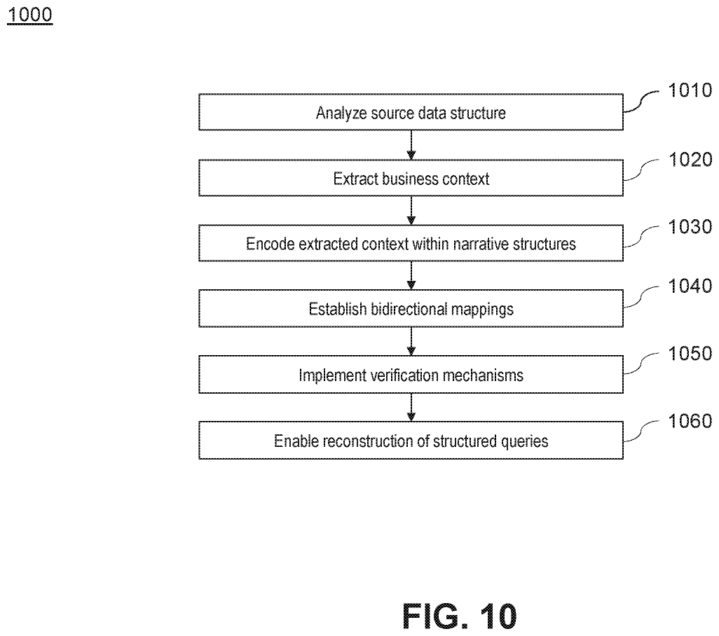

FIG. 10 depicts a flowchart of a method 1000 for maintaining context integrity in bidirectional data transformations in accordance with one or more non-limiting implementations of the present technology.

In one or more implementations, the server 220 comprises a processing device such as the processor 110 and/or the GPU 111 operatively connected to a non-transitory computer readable storage medium such as the solid-state drive 120 and/or the random-access memory 130 storing computer-readable instructions. The processing device, upon executing the computer-readable instructions, is configured to or operable to execute the method 1000.

The method 1000 may be implemented using some or all of the computing device 100 and/or system 200. The method 1000 may be used in conjunction with some or all of the method 300, the workflow 400, the software modules 500, the software architecture 600, the method 700, the method 800, and/or the software components 900.

The method 1000 begins at processing step 1010.

According to processing step 1010, the processing device analyzes source data structure to identify entity relationships, temporal sequences, hierarchical structures, and data types.

According to processing step 1020, the processing device extracts, from the source data structure, business context including business rules, relationship significance, temporal context, and domain terminology.

According to processing step 1030, the processing device encodes the extracted context within narrative structures using appropriate syntactic forms, terminology, and metadata.

According to processing step 1040, the processing device establishes bidirectional mappings between data elements and narrative components.

According to processing step 1050, the processing device implements verification mechanisms that validate contextual integrity during transformations.

According to processing step 1060, the processing device enables reconstruction of structured queries from narrative content while preserving full business context.

The method 1000 then ends.

In at least one implementation, the method 1000 is performed in a different order. In at least one implementation, the method 1000 is performed in such a manner that some or all of the steps are carried out iteratively.

In at least one embodiment, a first modified method for maintaining context integrity in bidirectional data transformations comprises only some of the steps in method 1000. In such a case, the first modified method may replace some of the missing steps with other steps to further achieve the goals of the present technology.

In at least one embodiment, a second modified method for maintaining context integrity in bidirectional data transformations comprises all of the steps in method 1000, as well as one or more additional steps. In such a case, the second modified method may add steps to further achieve the goals of the present technology.

In at least one embodiment, a non-transitory computer-readable medium (CRM) has stored thereon computer-executable instructions that, when executed by at least one processor, cause the at least one processor to perform the method 1000. The CRM may also have stored thereon additional computer-executable instructions, such as those of any of the implementations of method 1000 discussed herein.

In at least one embodiment, a system for maintaining context integrity in bidirectional data transformations comprises a processor and a non-transitory computer-readable medium have stored thereon computer-executable instructions. The computer-executable instructions, when run by the processor, cause the processor to carry out method 1000. The system may also have additional features, such as those of any of the implementations of method 1000 discussed herein. The system may also have additional features, such as those of any of the components and/or modules described herein.

### Data Flow for Enabling an LLM to Reason With Structured Enterprise Data

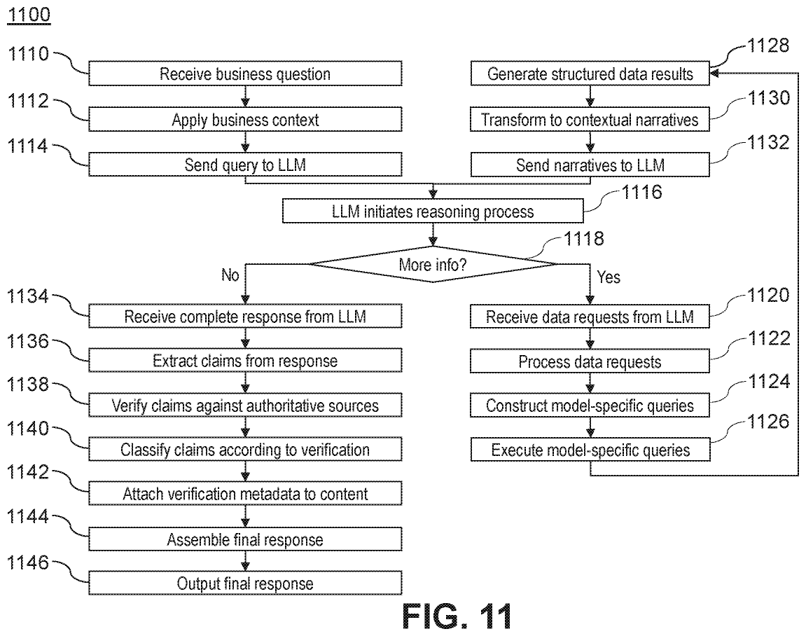

FIG. 11 depicts a flowchart of data flow 1100 in a system or method for LLM reasoning with structured enterprise data in accordance with one or more non-limiting implementations of the present technology.

In one or more implementations, the server 220 comprises a processing device such as the processor 110 and/or the GPU 111 operatively connected to a non-transitory computer readable storage medium such as the solid-state drive 120 and/or the random-access memory 130 storing computer-readable instructions. The processing device, upon executing the computer-readable instructions, is configured to or operable to execute the data flow 1100.

The data flow 1100 may be implemented using some or all of the computing device 100 and/or system 200. The data flow 1100 may be used in conjunction with some or all of the method 300, the workflow 400, the software modules 500, the software architecture 600, the method 700, the method 800, the software components 900, and/or the method 1000.

The data flow 1100 begins at step 1110.

According to step 1110, the system receives a business question submitted by a user through the interface component. This step may be associated with, for example, processing step 310 in method 300.

According to step 1112, the system applies business context and instructions to enrich the question with relevant metadata and domain-specific parameters. This step may be associated with, for example, step 415 in workflow 400.

According to step 1114, the enhanced query is transmitted to the Large Language Model (LLM) to initiate the reasoning process. This step may be associated with, for example, step 320 in method 300.

According to step 1116, the LLM begins its reasoning process by analyzing the query and determining what information is needed to generate a comprehensive response. This step may be associated with, for example, step 425 in workflow 400.

According to step 1118, the LLM evaluates whether additional information is required to continue its reasoning process and generate an accurate response. If No (i.e., additional information is not required), then the data flow 1110 proceeds to step 1134. If Yes (i.e., additional information is required), then the data flow 1110 proceeds to step 1120.

According to step 1120, the system receives protocol-conformant data requests from the LLM that specify what additional data is required (when more information is needed after evaluation in step 1118). This step may be associated with, for example, processing step 330 in method 300.

According to step 1122, the data access system processes these requests, routing them to the appropriate data model adapter based on the request type and target data source. This step may be associated with, for example, step 430 in workflow 400.

According to step 1124, the system constructs model-specific queries tailored to the underlying data structures of the relevant authoritative sources. This step may be associated with, for example, step 435 in workflow 400.

During steps 1122 and 1124, the Universal Data Modeling Interface provides a consistent API across multiple enterprise data modeling approaches through specialized adapters that abstract the specific implementation details of different data models. These steps may be associated with the universal data modeling interface 620 in the software architecture 600.

According to step 1126, the system executes these model-specific queries against authoritative data repositories to retrieve the requested structured data. This step may be associated with, for example, processing step 350 in method 300.

According to step 1128, the query execution generates structured data results that contain the information requested by the LLM, along with complete provenance metadata. In some implementations, step 1128 may be initiated prior to step 1116 (e.g., before step 1110, concurrently with step 1110, after step 1110 but before step 1116, etc.).

According to step 1130, the retrieved structured data results are transformed into contextually rich natural language narratives that preserve business context, relationships, and temporal aspects. This step may be associated with, for example, step 440 in workflow 400.

During steps 1128 and 1130, the Data-to-Narrative Transformation Engine converts structured query results into contextually rich natural language narratives suitable for LLM consumption while maintaining bidirectional traceability between narrative elements and source records. These steps may be associated with the data-to-narrative transformation engine 630 in the software architecture 600.

According to step 1132, these contextual narratives, which include embedded fact verification references, are provided to the LLM to incorporate into its ongoing reasoning process. This step may be associated with, for example, processing step 360 in method 300.

According to step 1134, once the LLM has sufficient information (i.e., when more information is not needed after evaluation in step 1118), it generates a complete response to the original query based on its reasoning process and the provided contextual narratives. This step may be associated with, for example, processing step 370 in method 300.

According to step 1136, the system extracts specific factual claims from the LLM's response for verification against authoritative sources. This step may be associated with, for example, step 450 in workflow 400.

According to step 1138, each extracted claim is verified against authoritative data sources using model-appropriate verification methods to determine its accuracy. This step may be associated with, for example, processing step 380 in method 300.

During steps 1136 and 1138, the Deterministic Assertion Verification System validates statements generated by the LLM against authoritative data sources through verified queries, implementing mechanisms to extract verifiable claims and classify them according to verification level. These steps may be associated with the deterministic assertion verification system 640 in the software architecture 600.

According to step 1140, the system classifies each verified claim according to a multi-tier verification framework that categorizes content based on verification level and confidence. This step may be associated with, for example, step 460 in workflow 400.

According to step 1142, verification metadata is attached to corresponding content elements, enabling transparency about the verification status of different parts of the response. This step may be associated with, for example, step 465 in workflow 400.

During steps 1140 and 1142, the Multi-tier Verification Classification Framework implements a structured classification system for generated content based on verification level, enabling clear communication of verification status to end users and supporting differentiated handling of content based on verification tier. These steps may be associated with the multi-tier verification classification system 650 in the software architecture 600.

According to step 1144, the final response is assembled with verification indicators that communicate the verification status of different content elements to the end user. This step may be associated with, for example, step 470 in workflow 400.

According to step 1146, the system outputs the verified final response to the user with appropriate indicators showing the verification status of different content elements. This step may be associated with, for example, processing step 390 in method 300.

The data flow 1100 then ends.

In at least one implementation, the data flow 1100 is executed in a different order. In at least one implementation, the data flow 1100 is executed in such a manner that some or all of the steps are executed iteratively.

In at least one embodiment, a first modified data flow for LLM reasoning with structured enterprise data comprises only some of the steps in the data flow 1100. In such a case, the first modified method may replace some of the missing steps with other steps to further achieve the goals of the present technology.

In at least one embodiment, a second modified data flow for LLM reasoning with structured enterprise data comprises all of the steps in the data flow 1100, as well as one or more additional steps. In such a case, the second modified data flow may add steps to further achieve the goals of the present technology.

In at least one embodiment, a non-transitory computer-readable medium (CRM) has stored thereon computer-executable instructions that, when executed by at least one processor, cause the at least one processor to execute the data flow 1100. The CRM may also have stored thereon additional computer-executable instructions, such as those of any of the implementations of the data flow 1100 discussed herein.

In at least one embodiment, a system for maintaining context integrity in bidirectional data transformations comprises a processor and a non-transitory computer-readable medium have stored thereon computer-executable instructions. The computer-executable instructions, when run by the processor, cause the processor to execute the data flow 1100. The system may also have additional features, such as those of any of the implementations of the data flow 1100 discussed herein. The system may also have additional features, such as those of any of the components and/or modules described herein.

### Example of Data Flow for Enabling an LLM to Reason With Structured Enterprise Data

The data flow 1100 in a system or method for LLM reasoning with structured enterprise data may be better understood with reference to an example. For the purposes of this example, the business question is: “What are my top 5 worst percentage margin projects in Q4?” The data flow shown with reference to this example is a non-limiting example that illustrates one possible implementation of the data flow 1100.

### Step 1110: Receive Business Question

The system receives the natural language business question “what are my top 5 worst percentage margin projects in Q4” from a business user seeking insights about underperforming projects.

### Step 1112: Apply Business Context

The system enriches the question with organizational context:
The organization's fiscal quarters are standard calendar quarters;
“Projects” represent client engagements with defined scope and deliverables;
“Margin” in the organization refers to profit margin which measures financial performance of each project.

### Step 1114: Send Query to LLM

The enhanced question is sent to the LLM with instructions to reason about what data is needed to properly answer this query, initiating the LLM's reasoning process.

### Step 1116: LLM Initiates Reasoning Process

The enhanced question is sent to the LLM which reasons about what data is needed to properly answer the query.

### Step 1118: LLM Determines Information Needs

The LLM analyzes the question and identifies several data requirements:
Project identification data (names, IDs, categories);
Revenue data for Q4 by project;
Cost data for Q4 by project;
Calculation methodology for percentage margin;
Time period definition for “Q4”;
Sorting logic for identifying “worst” performers.

### Step 1120: LLM Generates Data Requests

The LLM generates protocol-conformant data requests to retrieve necessary information:

```
DATA_REQUEST {
  type: “entity_lookup”,
  entity: “Project”,
  attributes: [“project_id”, “project_name”, “project_manager”, “client”],
  timeframe: “Q4_CURRENT_YEAR”
}
DATA_REQUEST {
  type: “financial_metrics”,
  entity: “Project”,
  metrics: [“revenue”, “total_cost”],
  timeframe: “Q4_CURRENT_YEAR”
}
DATA_REQUEST {
  type: “metadata”,
  entity: “TimeFrame”,
  definition: “Q4_CURRENT_YEAR”
}
DATA_REQUEST {
  type: “calculation_definition”,
  entity: “FinancialMetric”,
  metric: “percentage_margin”
}
```

### Step 1122: Process Data Requests

The system processes these data requests through the universal data modeling interface, which maps the requests to the Unified Business Data Model (UBDM). The UBDM represents all business processes as event-sourced activities and sequences.

### Step 1124: Construct Model-Specific Queries

The system generates model-specific queries for each data request against the UBDM. For example:

```
-- Project entity data
SELECT
  event_data->>‘project_id’ AS project_id,
  event_data->>‘project_name’ AS project_name,
  event_data->>‘project_manager’ AS project_manager,
  event_data->>‘client’ AS client
FROM business_events
WHERE event_type = ‘PROJECT_ACTIVE’
AND event_timestamp BETWEEN ‘2024-10-01’ AND ‘2024-12-31’
AND is_latest_state = TRUE;
-- Project financial metrics
SELECT
  project_id,
  SUM(CASE WHEN transaction_type = ‘REVENUE’ THEN amount ELSE 0 END) AS
revenue,
  SUM(CASE WHEN transaction_type = ‘EXPENSE’ THEN amount ELSE 0 END) AS
total_cost
FROM financial_transactions
WHERE timestamp BETWEEN ‘2024-10-01’ AND ‘2024-12-31’
GROUP BY project_id;
```

### Step 1126: Execute Queries Against UBDM

The system executes these model-specific queries against the UBDM, which maintains a chronological series of business events and activities for all projects, including their financial transactions, status changes, and associated metadata.

### Step 1128: Generate Structured Data Results

The UBDM returns structured data results from these queries, including:
List of active projects during Q4;
Financial performance data for each project;
Time period definition confirming Q4 refers to October-December 2024;
Confirmation that percentage margin is calculated as ((revenue−cost)/revenue)*100.

### Step 1130: Transform to Contextual Narratives

The data-to-narrative transformation engine converts the structured results into contextual narratives with business stories:
“Project Alpha (ID: P-1089) was a website redesign for client XYZ Corp that ran throughout Q4. The project was managed by Sarah Johnson and generated $180,000 in revenue with associated costs of $153,000. This resulted in a percentage margin of 15%, which is below the company target of 25% for web design projects. Timeline delays due to client feedback cycles contributed to increased labor costs.”
“Project Omega (ID: P-1124) was a custom CRM implementation for client ABC Industries that completed in Q4. The project was managed by Michael Chen and generated $250,000 in revenue with associated costs of $237,500. This resulted in a percentage margin of only 5%, significantly below expectations. Post-project analysis revealed scope creep in the requirements phase that was not captured in a formal change request.”

Similar narratives are generated for other projects, each embedding business context, causal relationships, and organizational knowledge along with the raw financial data.

### Embed Fact Verification References

Each narrative embeds fact verification references that enable later validation:
“Project Delta (ID: P-1156) was a mobile app development effort for client Acme Corp {ref: PROJECT_ENTITY: P-1156} that ran throughout Q4 {ref:TIME_PERIOD:Q4_2024}. The project generated $320,000 in revenue {ref:FINANCIAL:P-1156:REVENUE:Q4_2024} with associated costs of $288,000 {ref:FINANCIAL:P-1156:COST:Q4_2024}, resulting in a percentage margin of 10% {ref:CALCULATED: MARGIN: 10%: ((320000−288000)/320000)*100}.”

### Step 1132: Send Narratives to LLM

These enriched narratives are sent back to the LLM to incorporate into its reasoning process. The LLM can now understand not just the raw financial data but the business context and story behind each project's performance.

### Step 1134: LLM Generates Complete Response

The LLM processes the narrative information and generates a complete response that answers the original question while incorporating the business context:
“Based on Q4 financial data, here are your 5 projects with the worst percentage margins:
1. Project Sigma (1.2%): This research initiative for GlobalTech suffered from unexpected equipment costs and extended testing cycles that weren't anticipated in the original SOW.
2. Project Omega (5.0%): This CRM implementation for ABC Industries experienced significant scope creep that wasn't captured in change requests, leading to additional development hours without corresponding revenue increases.
3. Project Gamma (7.3%): This data migration project faced technical challenges with legacy system integration that required bringing in specialized resources at premium rates.
4. Project Delta (10.0%): This mobile app development for Acme Corp had an aggressive timeline that required additional staffing to meet deadlines, impacting overall profitability.
5. Project Alpha (15.0%): This website redesign had multiple revision cycles that extended the timeline and increased labor costs beyond initial estimates.
All these projects fell below your company's standard target margin of 25% for professional services engagements.”

### Step 1136: Extract Claims for Verification

The system extracts specific factual claims from the LLM's response for verification:
Project Sigma had a 1.2% margin;
Project Omega had a 5.0% margin;
Project Gamma had a 7.3% margin;
Project Delta had a 10.0% margin;
Project Alpha had a 15.0% margin;
Company has a 25% standard target margin.

### Step 1138: Verify Claims Against UBDM

The system verifies each claim against the authoritative UBDM source using the embedded fact verification references:
The margin calculations are verified by re-running the calculations with the source data;
The project details are verified against the project entity data;
The company standard target margin is verified against policy documents in the knowledge base.

### Step 1140: Classify Claims by Verification Level

The system classifies each verified claim according to the multi-tier verification framework.

### Tier 1 (Validated):

Project names and their calculated margins are directly traceable to UBDM records;
Financial data (revenue and costs) are directly sourced from verified transaction records.

### Tier 2 (Reasoned & Grounded):

The rankings of projects by margin percentage are derived through calculations on validated data;
The analysis of falling below target margins involves comparing validated margins to a verified target.

### Tier 3 (Inferred Insights):

The specific causes of margin issues (scope creep, extended timelines, etc.) are inferential analysis based on project notes and may contain some uncertainty.

### Step 1142: Attach Verification Metadata

The system attaches verification metadata to each content element in the response, indicating confidence levels and verification status.

### Step 1144: Assemble Final Response

The system assembles the final response with verification indicators, prioritizing the most reliable information while clearly indicating which insights are inferential:
“Based on Q4 financial data, here are your 5 projects with the worst percentage margins:
1. Project Sigma (1.2%) ✓: This research initiative for GlobalTech [likely suffered from unexpected equipment costs and extended testing cycles]*. ✓=Verified against financial records*=Based on project notes and may contain interpretive elements”
2. Project Omega (5.0%) ✓: This CRM implementation for ABC Industries [experienced significant scope creep based on project notes]*.
3. Project Gamma (7.3%) ✓: This data migration project [faced technical challenges with legacy system integration according to status reports]*.
4. Project Delta (10.0%) ✓: This mobile app development for Acme Corp had an aggressive timeline that required additional staffing.
5. Project Alpha (15.0%) ✓: This website redesign had multiple revision cycles that extended the timeline.
All these projects fell below your company's standard target margin of 25% for professional services engagements ✓.

### Step 1146: Output Final Response to User

The final response is presented to the user through the interface, with clear indicators of verification status and data lineage available on demand. The response maintains the business storytelling approach while ensuring factual accuracy of all claims.

### Data Flow in a Semantic Model for Using an LLM to Reason With Structured Data

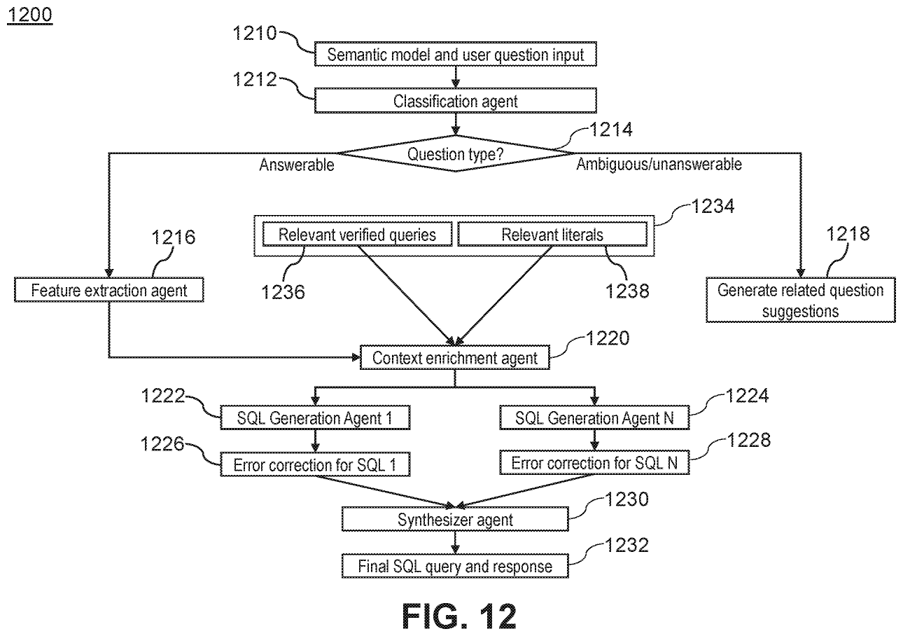

FIG. 12 depicts a flowchart of data flow 1200 in a semantic model for using an LLM to reason with structured data. The data flow 1200 is provided for comparison with the data flow 1100, for example, to show differences between a semantic model for using an LLM to reason with structured data and the systems and methods for LLM reasoning with structured enterprise data described herein. The data flow 1200 represents an alternative approach that does not incorporate the narrative transformation, bidirectional traceability, or multi-tier verification classification that characterize the present technology. It is presented for illustrative and comparative purposes only.

The data flow 1200 begins at step 1210.

According to step 1210, the system receives inputs from two sources: a semantic model that provides context about the data schema and a natural language question from a business user.

According to step 1212, the classification agent analyzes the incoming question to determine if it is answerable, ambiguous, or outside the scope of data questions that can be handled reliably.

According to step 1214, the system evaluates the question type based on the classification agent's analysis to determine the appropriate processing path. If the question type is answerable, then the data flow 1200 proceeds to step 1216. If the question type is ambiguous/unanswerable, then the data flow 1200 proceeds to step 1218.

According to step 1216, for answerable questions, the feature extraction agent analyzes the question to identify specific characteristics such as time-series requirements, period-over-period calculations, rank calculations, and other analytical patterns.

According to step 1218, for ambiguous or unanswerable questions, the system generates related question suggestions that are unambiguous and can be answered confidently, preventing potential hallucinations.

According to step 1220, the context enrichment agent processes the semantic model with additional context relevant to answering the specific question, incorporating verified queries and relevant literals.

According to step 1222, SQL Generation Agent 1 creates a SQL query based on the enriched context and identified features of the question.

According to step 1224, SQL Generation Agent N creates an alternative SQL query, as multiple LLMs are employed to increase robustness and accuracy in query generation.

According to step 1226, the error correction agent checks the SQL from Agent 1 for both syntactic and semantic errors using an SQL compiler, fixing any issues through an iterative correction process.

According to step 1228, similarly, the error correction agent checks and fixes the SQL from Agent N for both syntactic and semantic errors.

According to step 1230, a synthesizer agent reviews multiple candidate SQL queries along with their context and generates a final, optimized SQL query that best answers the user's question.

According to step 1232, the system outputs the final response including the question interpretation and executable SQL query that accurately answers the original business question.

The data flow 1200 includes context enrichment components that are configured to carry out steps 1234, 1236, and 1238.

According to step 1234, the context enrichment process incorporates multiple components to provide relevant information for accurate SQL generation.

According to step 1236, relevant verified queries are retrieved from a repository of previously validated SQL queries that have been confirmed as correct by human analysts.

According to step 1238, relevant literals are identified through semantic search to bridge vocabulary gaps between business terminology in questions and actual data values in the database.

The data flow 1200 then ends.

The data flow 1200 may further include an SQL generation process. The SQL generation process may follow a specialized approach to handle complex schema structures:
A logical schema construction transforms the complex physical schema into a simplified logical schema that is easier for the LLMs to process accurately.
SQL generation against the logical schema allows the LLM to create queries using the simplified structure without being overwhelmed by the full complexity of the physical schema.
Post-processing transforms the logical SQL into executable SQL that works against the actual physical schema in the database.

### First Example of Data Flow in a Semantic Model for Using an LLM to Reason With Structured Data

The data flow 1200 in a semantic model for using an LLM to reason with structured data may be better understood with reference to an example. For the purposes of this example, the business question is: “What are my top 5 worst percentage margin projects in Q4?”. The data flow shown with reference to this example illustrates an implementation of the data flow 1200. In this first example, the semantic layer has the answers.

### Step 1210: Semantic Model and User Question Input

The system receives the natural language question “what are my top 5 worst percentage margin projects in Q4” along with the semantic model containing metadata about project data, margin calculations, and time period definitions.

### Step 1212: Classification Agent Analysis

The classification agent analyzes the question and determines:
This is a data question (requires querying database);
It is answerable (contains clear metrics and constraints);
It requires SQL generation (needs to query structured data);
It passes classification checks (not ambiguous, has clear intent).

### Step 1214: Question Type Determination

The system recognizes this as an answerable question and routes it for further processing rather than suggesting alternative questions.

### Step 1216: Feature Extraction

The feature extraction agent identifies the following characteristics:
Ranking operation: “top 5” indicates limiting and ordering results;
Sorting direction: “worst” indicates ascending order for margin percentage;
Metric calculation: “percentage margin” requires a formula calculation;
Entity focus: “projects” is the main business entity;
Time filter: “Q4” indicates a quarter-based time constraint.

### Steps 1236, 1238: Context Enrichment Components

The system identifies a verified query that previously calculated project margins.

The system confirms that calculating “percentage margin” typically requires (revenue-cost)/revenue formula.

The system verifies that in this database, “Q4” corresponds to months 10-12 or specific date range.

### Step 1220: Context Enrichment

The context enrichment agent enhances the request with:
Verified queries: Retrieves similar margin calculation queries from the repository;
Relevant literals: Identifies “Q4” could be represented as “Q4”, “4”, “Quarter 4” or specific date ranges in the database;
Schema information: Determines which tables contain project data and margin components.

### SQL Generation Process

The logical schema identifies the key tables: Projects, Financials, TimeData.

The system identifies that margin percentage requires joining Projects to Financials tables and applying time filters.

### Step 1222: SQL Generation Agent 1

The first SQL agent generates a query using the Meta Llama model:

```
SELECT
  p.project_name,
  ((f.revenue − f.cost) / NULLIF(f.revenue, 0)) * 100 AS margin_percentage
FROM projects p
JOIN financials f ON p.project_id = f.project_id
JOIN time_data t ON f.time_id = t.time_id
WHERE t.quarter = ‘Q4’
ORDER BY margin_percentage ASC
LIMIT 5
```

### Step 1224: SQL Generation Agent N

The second SQL agent generates an alternative query using the Mistral AI model:

SELECT
project_name,
(revenue − total_cost)/revenue * 100 AS percent_margin
FROM project_financials
WHERE quarter_name = ‘Q4’ AND revenue > 0
ORDER BY percent_margin ASC
LIMIT 5

### Steps 1226, 1228: Error Correction

The error correction agent identifies issues with both queries:
In Agent 1's query: Potential division by zero if revenue is 0;
In Agent N's query: Column names don't match semantic model's definitions.

The agent corrects these issues in both queries to ensure they are executable.

### Step 1230: Synthesizer Agent

The synthesizer agent evaluates both corrected queries and creates an optimized final query that incorporates the best elements:

```
SELECT
  p.project_name,
  p.project_id,
  ((f.revenue − f.cost) / NULLIF(f.revenue, 0)) * 100 AS margin_percentage
FROM projects p
JOIN financials f ON p.project_id = f.project_id
WHERE f.quarter = ‘Q4’
  AND f.year = EXTRACT(YEAR FROM CURRENT_DATE( ))
ORDER BY margin_percentage ASC
LIMIT 5
```

### Step 1232: Final SQL Query and Response

The system returns the final response to the user:
Question Interpretation: “Find the 5 projects with the lowest profit margin percentages (calculated as (revenue-cost)/revenue) during the fourth quarter of the current year.”
SQL Query: The optimized query shown above.
Result: A table showing the 5 projects with the lowest margin percentages in Q4, presented in ascending order of margin percentage.

### Second Example of Data Flow in a Semantic Model for Using an LLM to Reason With Structured Data

The data flow 1200 in a semantic model for using an LLM to reason with structured data may be better understood with reference to an example. For the purposes of this example, the business question is: “What are my top 5 worst percentage margin projects in Q4?”. The data flow shown with reference to this example illustrates an implementation of the data flow 1200. In this second example, the semantic layer does not have the answer.

### Step 1210: Semantic Model and User Question Input

The system receives the natural language question “what are my top 5 worst percentage margin projects in Q4” along with the semantic model. In this example, the semantic model contains project data, revenue and cost metrics, but does not have a pre-defined “margin” calculation.

### Step 1212: Classification Agent Analysis

The classification agent analyzes the question and determines:
This is a data question (requires querying database);
It requires derivation of a metric not explicitly defined in the semantic model;
It is answerable but requires formula inference;
It passes classification checks with some inference required.

### Step 1214: Question Type Determination

The system recognizes this as an answerable question requiring derivation of metrics and proceeds with processing.

### Step 1216: Feature Extraction

The feature extraction agent identifies the following characteristics:
Ranking operation: “top 5” indicates limiting and ordering results;
Sorting direction: “worst” indicates ascending order for the derived metric;
Derived metric: “percentage margin” requires inference and formula derivation;
Entity focus: “projects” is the main business entity;
Time filter: “Q4” indicates a quarter-based time constraint;
Calculation need: System identifies that margin calculation will need to be derived from available financial metrics.

### Step 1236, 1238: Context Enrichment Components

The system retrieves a verified query that manipulates project financial data.

The system determines that although “margin” is not defined, the necessary components (revenue and cost) are available.

The system identifies that “percentage margin” should be calculated as ((revenue−cost)/revenue)*100.

The system verifies that “Q4” corresponds to months 10-12 or a specific date range.

### Step 1220: Context Enrichment

The context enrichment agent enhances the request with:
Verified queries: Retrieves queries that work with revenue and cost data for projects;
Financial knowledge: Identifies that “percentage margin” typically needs to be calculated using revenue and cost fields;
Relevant literals: Identifies “Q4” could be represented as “Q4”, “4”, “Quarter 4” or specific date ranges in the database;
Schema exploration: Identifies tables with revenue and cost data necessary for margin calculation.

### SQL Generation Process

The logical schema identifies the projects table and financial metrics table containing revenue and cost fields.

The system determines it needs to join these tables and create a derived calculation for margin.

### Step 1222: SQL Generation Agent 1

The first SQL agent generates a query, inferring the margin calculation:

```
SELECT
  p.project_name,
  p.project_id,
  f.revenue,
  f.cost,
  ((f.revenue − f.cost) / NULLIF(f.revenue, 0)) * 100 AS percentage_margin
FROM projects p
JOIN financial_metrics f ON p.project_id = f.project_id
WHERE f.time_period = ‘Q4’
  AND f.year = EXTRACT(YEAR FROM CURRENT_DATE( ))
ORDER BY percentage_margin ASC
LIMIT 5
```

### Step 1224: SQL Generation Agent N

The second SQL agent generates an alternative calculation approach:

```
SELECT
  p.project_name,
  p.project_id,
    ((f.revenue − f.total_expenses )/ NULLIF(f.revenue, 0)) * 100 AS
profit_margin_percentage
FROM project_details p
JOIN project_financials f ON p.id = f.project_id
WHERE f.quarter = ‘Q4’
ORDER BY profit_margin_percentage ASC
LIMIT 5
```

### Step 1226, 1228: Error Correction

The error correction agent identifies several issues:
First query uses “cost” but needs to verify this is the correct field for all project expenses;
Second query uses “total_expenses” which may not map to the actual field name;
Both queries need consistent NULLIF handling to prevent division by zero;
Time period filtering needs proper field references.

The agent makes corrections based on the actual schema:

```
-- Corrected first query
SELECT
  p.project_name,
  p.project_id,
  ((f.revenue − f.cost) / NULLIF(f.revenue, 0)) * 100 AS percentage_margin
FROM projects p
JOIN financial_metrics f ON p.project_id = f.project_id
WHERE f.quarter_id = 4
  AND f.fiscal_year = EXTRACT(YEAR FROM CURRENT_DATE( ))
ORDER BY percentage_margin ASC
LIMIT 5
```

### Step 1230: Synthesizer Agent

The synthesizer agent evaluates the different approaches and creates a final query:

```
SELECT
  p.project_name,
  p.project_id,
  f.revenue,
  f.cost,
  CASE
    WHEN f.revenue = 0 THEN NULL
    ELSE ((f.revenue − f.cost) / f.revenue) * 100
  END AS percentage_margin
FROM projects p
JOIN financial_metrics f ON p.project_id = f.project_id
WHERE f.quarter_id = 4
  AND f.fiscal_year = EXTRACT(YEAR FROM CURRENT_DATE( ))
ORDER BY percentage_margin ASC
LIMIT 5
```

### Step 1232: Final SQL Query and Response

The system returns the final response to the user:
Question Interpretation: “I understand you're looking for the 5 projects with the worst profit margins (as a percentage) in the fourth quarter. Since margin isn't directly defined in your data, I've calculated it as the percentage of revenue that remains as profit after subtracting costs ((revenue−cost)/revenue)*100.”
SQL Query: the optimized query shown above.
Result: A table showing the 5 projects with the lowest margin percentages in Q4, presented in ascending order of the calculated percentage margin.
Note to User: “The margin percentage was calculated as ((revenue−cost)/revenue)*100. Projects with zero revenue are excluded from the calculation.”

### Implementation Details

The method 300, the workflow 400, the software modules 500, the software architecture 600, the method 700, the method 800, the software components 900, the method 1000, and/or the data flow 1100 (or one or more parts thereof) may be implemented using one or more of the protocols, processes, models, methodologies, and/or approaches described herein.

### Data Request Protocol Specification

In one or more implementations, the present technology implements a structured protocol that enables LLMs to request specific data during reasoning. This protocol defines:

### 1. Request Format Specification: A Structured Format (e.g., JSON or XML) That Includes:

Request type identifier;
Data source identifier;
Query parameters;
Context requirements; and/or
Response format preferences.

### 2. Request Types:

Direct fact lookup;
Relational query;
Temporal query;
Aggregation calculation; and/or
Multi-entity relationship query.

### 3. Response Format Specification: A Structured Format That Includes:

Result data;
Source provenance;
Confidence indicators;
Contextual metadata; and/or
Temporal information.

### 4. Error Handling Protocol: Defined Responses for:

Data not found;
Ambiguous queries;
Authorization failures;
Execution errors; and/or
Timeout conditions.

### Narrative Construction Process

The construction of reasoning narratives from structured data is a component of the present technology. This process varies based on the underlying data model but may follow a general pattern:

### 1. For Relational/Entity-Relationship Models:

The system identifies primary entities and their relationships through foreign key connections. It constructs narratives that describe entity attributes and their relationships, traversing join paths to create coherent stories about related entities. Temporal aspects are derived from timestamp fields, with appropriate sequencing in the narrative.

### 2. For Dimensional Models:

Narratives are constructed around fact tables and their associated dimension tables. Metrics from fact tables are described in the context of their dimensions, with appropriate business terminology derived from dimension attributes. Hierarchical dimensions (like time or geography) are represented with appropriate levels of detail.

### 3. For Data Vault Models:

The system traverses hub-link-satellite structures to create temporally accurate narratives. Hubs provide the core entities, links establish relationships, and satellites provide descriptive and temporal attributes. The narrative respects the historical tracking inherent in the data vault model, clearly indicating point-in-time accuracy.

### 4. For Hierarchical/Network Models:

Narratives follow the hierarchical structure of the data, describing parent-child relationships and sibling connections. The system preserves the hierarchical context in the narrative structure, ensuring that relationships between levels are clearly articulated.

### 5. For Graph Models:

The system traverses nodes and edges to build narratives that emphasize relationships between entities. Properties of both nodes and edges are incorporated into the narrative, with path information preserved to show how entities are connected through potentially complex networks.

### 6. For Object-Oriented Models:

Narratives incorporate both object attributes and behaviors, describing not just the static properties but also the dynamic aspects of objects. Inheritance relationships are reflected in the narrative structure, with appropriate attribution of properties to their defining classes.

### 7. For Document-Oriented/NoSQL Models:

The system extracts and organizes document fields into contextually relevant narratives, handling varying document structures and nested elements. Arrays and nested documents are transformed into appropriate list-based or hierarchical narratives.

### 8. For Columnar Models:

The system reconstructs row context from columnar storage, creating entity-centric narratives despite the column-oriented physical storage. Aggregations commonly used with columnar stores are translated into summary narratives that preserve their analytical meaning.

### 9. For Semantic Layers:

Narratives leverage the business-friendly terminology and relationships defined in the semantic layer, creating descriptions that align with enterprise business language. Calculated metrics and KPIs are explained in business terms with their derivation logic incorporated into the narrative.

### Verification Methodology

The verification process may adapt to different data models, employing a system of verified queries to ensure deterministic validation.

Verified Query Mechanism—the present technology can leverage verified queries that provide a critical foundation for the verification process. These verified queries:
1. Query Validation: Each data retrieval operation uses a verified query that is syntactically validated and semantically checked against the data model.
2. Provenance Embedding: Verified queries embed complete provenance information, including:
Unique query identifier (UUID);
Complete query text with all parameters;
Parameter values used in execution;
Result schema information; and/or
Execution context metadata.
3. Query Persistence: Verified queries are persisted alongside the narrative content they generate, creating an immutable audit trail between assertions and their data sources.
4. Re-execution Capability: Verified queries can be re-executed to validate assertions at any point, enabling verification even when direct record referencing is not possible.
5. Multi-part Query Support: For complex assertions that require multiple data sources, the system supports verified query chains that document the complete derivation path of an assertion.

This verified query approach ensures Tier 1 level verification even in data models where direct unique referencing of facts is not possible, such as in Unified Business Data Models (UBDM) or other complex enterprise data architectures.

Model-Specific Verification Approaches—The verification process adapts to different data models using specialized verification strategies:

### 1. For Relational/Entity-Relationship Models:

Verification uses SQL verified queries with joins across related tables to confirm facts, with careful attention to join conditions to avoid false positives from incorrect relationships. The verified query contains the exact SQL, parameters, and execution context.

### 2. For Dimensional Models:

Verification involves verified queries against fact tables constrained by appropriate dimension filters, with aggregation operations to confirm summary statements. The verified query preserves dimensional context and aggregation logic.

### 3. For Data Vault Models:

Verification includes temporal context, using verified queries that access the appropriate satellite records based on the timeframe referenced in the assertion, with hub and link traversals to confirm relationships. The verified query captures the point-in-time nature of the data extraction.

### 4. For Hierarchical/Network Models:

Verification follows hierarchical paths using verified queries that confirm parent-child relationships and attribute values, with specialized traversal logic for network model set relationships. The verified query documents the traversal path.

### 5. For Graph Models:

Verification uses verified queries with path traversals and pattern matching to confirm relationships between entities, with property checks to validate attribute claims. The verified query preserves the graph traversal pattern.

### 6. For Object-Oriented Models:

Verification employs verified queries that check object attributes and traverse object relationships, applying inheritance rules to validate claims about derived properties. The verified query captures the object navigation path.

### 7. For Document-Oriented/NoSQL Models:

Verification uses verified queries that search document collections with appropriate filters, handling nested fields and arrays with specialized query operators. The verified query includes the exact filter specifications and field selectors.

### 8. For Columnar Models:

Verification constructs verified queries optimized for columnar execution patterns, leveraging fast aggregation capabilities for summary validation. The verified query preserves columnar-specific optimizations.

### 9. For Semantic Layers:

Verification translates business terminology into verified queries with underlying technical implementations, mapping business concepts to their technical implementations for validation. The verified query maintains both business and technical representations.

### Implementation Variations

The method 300, the workflow 400, the software modules 500, the software architecture 600, the method 700, the method 800, the software components 900, the method 1000, and/or the data flow 1100 (or one or more parts thereof) may be implemented using one or more technical variations:
Protocol specifications may use JSON, XML, or custom markup formats;
Data access adapters may be implemented for various data stores and modeling approaches;
Transformation pipelines may employ rule-based systems, statistical models, or neural language generators;
Verification engines may implement exact matching, semantic matching, or inference-based verification;
Verified query implementations may vary in storage formats, persistence mechanisms, and re-execution strategies;
Classification systems may use rule-based approaches or statistical methods; and/or
User interfaces may display verification status through various visualization techniques.

Verified Query Implementation Details—The verified query system can be implemented with one or more technical variations:

### 1. Storage Format Variations:

XML-based representations with explicit tagging of query components;
JSON structures with nested query information;
Binary serialization formats for efficient storage and retrieval; and/or
Linked data formats that connect queries to resulting assertions.

### 2. Persistence Mechanism Variations:

Database storage with indexing for efficient retrieval;
Blockchain-based immutable ledgers for tamper-proof verification;
Distributed verification repositories with consensus mechanisms; and/or
File-based storage with cryptographic checksums.

### 3. Query Generation Approaches:

Template-based query generation with parameter binding;
Dynamic query construction with optimization;
Query translation from abstract query models; and/or
Natural language to query transformation with verification.

### 4. Re-Execution Strategies:

On-demand re-execution for verification;
Scheduled re-verification to detect data changes;
Incremental re-verification of affected assertions; and/or
Parallel verification with consistency checking.

### Technical Advantages

In at least one of the embodiments of the present technology described herein, the embodiment or embodiments have one or more of the following technical advantages:
1. Dynamic Reasoning-Driven Data Access: The Embodiment(s) implements a technical protocol enabling LLMs to formulate and submit data requests during the reasoning process, fundamentally changing how LLMs interact with enterprise data.
2. Universal Data Model Compatibility: The architecture accommodates diverse enterprise data modeling approaches through a unified interface, enabling deployment across heterogeneous environments.
3. Bidirectional Context Preservation: The narrative transformation engine preserves context, relationships, and business meaning during conversion between structured data and natural language, overcoming context fragmentation.
4. Deterministic Verification Infrastructure: The assertion verification system provides technical mechanisms to validate every generated fact against authoritative sources, addressing the hallucination problem at its technical root. The fact verification embeddings/markers inserted during narrative generation travel through the LLM's reasoning process and emerge in the complete response, enabling deterministic end-to-end verification of claims against the same authoritative sources that produced the original data-creating a closed verification loop that spans the LLM's reasoning.
5. Verified Query Approach: The ability to use verified queries enables high-confidence verification even in complex data models where direct record referencing is not possible, extending reliable verification to all enterprise data architectures.
6. Transparent Reasoning Architecture: The embodiment(s) exposes verification status and reasoning chains through explicit technical mechanisms, enabling users to understand not just what was concluded but how, with what facts, and with what level of confidence.
7. Calculation Offloading: The architecture implements technical pathways to delegate computational tasks to deterministic systems rather than relying on probabilistic processing by LLMs, ensuring numerical accuracy.
8. Unified Technical Framework: The embodiment(s) provides a unified technical architecture that integrates data access, transformation, reasoning, and verification into a cohesive system with consistent handling of context and verification throughout.

### Additional Considerations

It should be apparent to those skilled in the art that at least some implementations of the present technology aim to expand a range of technical solutions for addressing one or more particular technical problems faced by systems for enabling an LLM to reason with structured enterprise data, such as inefficiency and cost (e.g., from a computing power standpoint), which may save computational resources, reduce computing power, or make more efficient use of network bandwidth.

It should be expressly understood that not all technical effects mentioned herein need to be enjoyed in each and every implementation of the present technology. For example, implementations of the present technology may be implemented without the user enjoying some of these technical effects, while other non-limiting implementations may be implemented with the user enjoying other technical effects or none at all.

Some processing steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A system for enabling a large language model (LLM) to reason with structured data, the system comprising:
a processor; and
a non-transitory storage medium operatively connected to the processor, the non-transitory storage medium comprising computer-readable instructions;
the processor, upon executing the instructions, being configured for:
receiving a question;
generating an initial query based on the question and sending the initial query to the LLM;
receiving a data request from the LLM in response to the query;
processing the data request to construct at least one model-specific query;
executing the at least one model-specific query against one or more authoritative sources of structured data, thereby obtaining a structured data result;
generating a contextual narrative based on the structured data result and sending the contextual narrative to the LLM;
receiving a complete response to the initial query from the LLM; and
outputting the complete response.

2. The system of claim 1, wherein the processor is further configured for:
verifying claims made in the complete response against the one or more authoritative sources, thereby generating categorizations of each of the claims that were verified; and
generating a final response based on the complete response and the categorizations,
wherein said outputting the complete response comprises outputting the final response.

3. The system of claim 1, wherein the question is a business question and the processor is further configured for applying at least one of a business context and instructions to the business question to prepare the initial query.

4. The system of claim 1, wherein the sending the initial query to the LLM causes the LLM to carry out an initial reasoning process on the query.

5. The system of claim 1, wherein the data request is protocol-conformant and follows a standardized protocol specification.

6. The system of claim 1, wherein said processing the data request comprises inputting the data request through a universal data modeling interface with appropriate data model adapters.

7. The system of claim 6, wherein the processor is further configured for constructing the at least one model-specific query from the data request using the data model adapters.

8. The system of claim 7, wherein said executing the at least one model-specific query against the one or more authoritative sources of structured data is carried out using the data model adapters.

9. The system of claim 1, wherein said generating the contextual narrative is performed using a narrative transformation engine that maintains bidirectional mappings.

10. The system of claim 1, wherein said sending the contextual narrative to the LLM causes the LLM to incorporate the contextual narrative into a subsequent reasoning process to generate the complete response to the initial query.

11. The system of claim 2, wherein the processor is further configured for extracting the claims from the complete response for verification.

12. The system of claim 11, wherein said verifying the claims made in the complete response is further based on fact verification embeddings inserted into the contextual narrative and the complete response.

13. The system of claim 2, wherein said verifying the claims made in the complete response generates an audit trail.

14. The system of claim 13, wherein said generating the final response is further performed based on the audit trail.

15. The system of claim 2, wherein said verifying the claims made in the complete response comprises using model-appropriate verification methods applied to the claims as related to the at least one model-specific query.

16. The system of claim 2, wherein the processor is further configured for classifying each of the claims that were verified according to a verification framework that categorizes content within the claims that were verified into specific verification tiers.

17. The system of claim 11, wherein the processor is further configured for attaching the fact verification embeddings to corresponding content elements for each of the claims that were verified.

18. The system of claim 2, wherein said outputting the final response comprises at least one of displaying the final response on a user interface, displaying the final response on a user device, sending the final response to a server to cause the final response to be output to a computing device connected to the server, and displaying the final response on a remote device.

19. A method for enabling a large language model (LLM) to reason with structured data, the method being executed by a processor, the method comprising:
receiving a question;
generating an initial query based on the question and sending the initial query to the LLM;
receiving a data request from the LLM in response to the query;
processing the data request to construct at least one model-specific query;
executing the at least one model-specific query against one or more authoritative sources of structured data, thereby obtaining a structured data result;
generating a contextual narrative based on the structured data result and sending the contextual narrative to the LLM;
receiving a complete response to the initial query from the LLM; and
outputting the complete response.

20. The method of claim 19, further comprising:
verifying claims made in the complete response against the one or more authoritative sources, thereby generating categorizations of each of the claims that were verified; and
generating a final response based on the complete response and the categorizations,
wherein said outputting the complete response comprises outputting the final response.
